(19) United States
(12) Patent Application Publication
(10) Pub. No.: US 2002/0004787 A1
(43) Pub. Date: Jan. 10, 2002

(54) Method for conducting an exchange over a network

(76) Inventors: David Clive Moshal, San Francisco, CA (US); Makarand R. Gokhale, Sunnyvale, CA (US); Michael Ames Lenz, Mountain View, CA (US); John Arnold Mount, San Francisco, CA (US); Lonnie Jackson Eldridge, San Mateo, CA (US)

Correspondence Address: WILSON SONSINI GOODRICH & ROSATI, 650 PAGE MILL ROAD, PALO ALTO, CA, 943041050

(21) Appl. No.: 09/821,704

(22) Filed: Mar. 28, 2001

Related U.S. Application Data
(60) Provisional application No. 60/192,533, filed on Mar. 28, 2000.

(51) Int. Cl. G06F 17/60

(52) U.S. Cl. 705/80

(57) ABSTRACT

A plurality of electronic exchange are conducted over a network. Each exchange is conducted between a plurality of traders, including a set of sellers and a set of bidders. The exchange determines a transactional value of an item. A plurality of requests are made to initiate the exchanges. A plurality of parameters are identified for each exchange. A plurality of offers are received. For an exchange, a settlement criteria is designated from the plurality of parameters. The settlement criteria is used to select one of the plurality of offers for that exchange to determine the transactional value of the item. An external event is detected over the network. Then, the transactional value of the item is determined for that exchange using the selected offer.

### PRIORITY INFORMATION

This application claims priority to U.S. Prov. Application No. 60/192,533 to Moshal et al., entitled “Universal Trading Engine and Multi Parametric Auction Engine,” filed Mar. 28, 2000. The aforementioned priority application is hereby incorporated by reference.

### BACKGROUND OF THE INVENTION

1. Field of the Invention

This invention relates to the field of configurable network interactions. In particular, the invention relates to configurable electronic exchanges between terminals on a network.

2. Description of the Related Art

The wide spread use of network technology has fostered growth in on-line transactions. In particular, electronic exchanges now are integrated with Internet technology to enhance the transaction environment of participants. Several examples of such exchanges exist.

EBAY offers an Internet auction house, primarily for consumers. Sellers on EBAY may provide items for sale using a traditional bidding auctions, a Dutch auctions, or a reserve price auctions. The seller chooses the type of auction before it begins. The auction is then carried out for a duration of time to its completion. Once started, the user cannot change the conditions of the auction.

Brokers now offer users Internet-access to the public stock exchanges across the globe. Users can purchase securities on such exchanges using Internet terminals. Users can view real-time bid and ask offers for securities, and submit offers for the securities that is electronically delivered to the dealers of the securities.

In general, auction and electronic exchanges offer limited variations. Any variation to implementation of electronic exchanges is made through selection amongst entire auction systems.

### SUMMARY OF THE INVENTION

An embodiment of the invention includes a method or system for plurality of exchanges, conducted over a network between a set of sellers and a set of bidders. The set of sellers includes at least a first seller on a first terminal coupled to the network. The set of bidders includes at least a first bidder on a second terminal coupled to the network. Each exchange is conducted to determine a transactional value of an item. A plurality of parameters are identified with each of the plurality of requests to configure the exchange according to a combination of instructions.

Another embodiment of the invention includes a method or system for conducting a plurality of electronic exchange over a network. Each exchange is conducted between a plurality of traders, including a set of sellers and a set of bidders. The exchange determines a transactional value of an item. A plurality of requests are made to initiate the exchanges. A plurality of parameters are identified for each exchange. A plurality of offers are received. For an exchange, a settlement criteria is designated from the plurality of parameters. The settlement criteria is used to select one of the plurality of offers for that exchange to determine the transactional value of the item. An external event is detected over the network. Then, the transactional value of the item is determined for that exchange using the selected offer.

An engine is provided for conducting electronic exchanges between sellers and bidders. The engine includes a lot handler module which processes each exchange as a lot object. The lot handler module associates each lot object with a strategy object. The strategy object associated with the lot object is for determining the transactional value of the item from at least one offer in a plurality of offers received in the exchange. The lot objects maybe stored in a lot container module.

### BRIEF DESCRIPTION OF THE FIGURES

FIG. 1 is a system diagram of a universal trading system, under an embodiment of the invention.

FIG. 2 is a flow chart for configuring exchanges operated on the trading system, under an embodiment of the invention.

FIGS. 3A-3C illustrate data objects used with embodiments of the invention.

FIG. 3A illustrates a lot object and a strategy object.

FIG. 3B illustrates a lot object and a strategy object for conducting a Dutch Auction type exchange.

FIG. 3C illustrates a lot object and a strategy object for conducting an English Auction type exchange.

FIGS. 4A and 4B illustrate use of an exchange engine in the trading system, under an embodiment of the invention.

FIG. 4A illustrates a system diagram for the exchange engine.

FIG. 4B illustrates a system diagram of the exchange engine when storing a plurality of lot objects.

FIGS. 5A-5C are process flows illustrating the exchange engine decoding messages, under an embodiment of the invention.

FIG. 5A illustrates a process in which a message to the exchange engine is decoded for several types of messages.

FIG. 5B illustrates a process in which a message to the exchange engine is decoded to identify replacement offer messages.

FIG. 5C illustrates a process in which a message to the exchange engine is decoded delete offer messages.

FIG. 6 is a flow process illustrating the exchange engine creating a new lot, under an embodiment of the invention.

FIG. 7 is a flow process illustrating the exchange engine handling new offers, under an embodiment of the invention.

FIG. 8 is a flow process illustrating the exchange engine matching offers to create pending orders, under an embodiment of the invention.

FIG. 9 is a flow process illustrating exchange engine replacing one strategy for an exchange with another strategy, under an embodiment of the invention.

FIGS. 10A-10E are match state diagrams illustrating a matching process for different types of exchanges, as performed by the exchange engine under an embodiment of the invention.

FIG. 10A is a match state diagram for a General Exchange strategy.

FIG. 10B is a match state diagram for a Dutch Auction type exchange.

FIG. 10C is a match state diagram for a Japanese Auction type exchange.

FIG. 10D is a match state diagram illustrating a settlement policy implemented at a particular time.

FIG. 10E is a match state diagram illustrating a direction of an exchange.

FIG. 11 is a chart illustrating a operational guidelines for the exchange engine, under an embodiment of the invention.

FIG. 12 is a user-interface for use with an embodiment of the invention.

### DETAILED DESCRIPTION

A. System Overview

An embodiment of the invention includes a system to power exchanges and marketplaces over networks such as the Internet, by providing software and support that allow dynamic pricing of goods and services. In contrast to previous systems that provide static pricing techniques, embodiments of the invention provide dynamic pricing to allow real-time adjustment of prices for purpose of capturing excess value, conducting price discovery, and creating exciting on-line marketplaces. Advantages provided include continuous trading, high transaction volume capacity, customizable information and transaction feedback. Furthermore, the system is data driven and highly configurable, enabling flexibility with high-capacity.

There are many types of exchanges—forward, reverse, many-to-one and many-to-many. Examples of existing Internet exchanges include on-line auctions. These existing exchanges generally comprise inflexible and hard-coded software routines to emulate a certain auction type, such as the forward or reverse auction. In contrast, embodiments of the invention employ common characteristics between auction types. The common characteristics of these exchanges have been abstracted into a small subset of shared, common parameters. A system provided under an embodiment of the invention implements efficient trading software that generates exchanges and auctions based on the common parameters. By varying these parameters, multiple existing and new types of auction, exchanges and other price interactions may be created and conducted for multiple traders using a network such as the Internet.

In one embodiment, a trading system is configured to receive 22 parameters (the exact number can vary based on market requirements), to execute 26 well-defined auction types, with over 700 distinct configurations of the auction types. When all possible permutations of the parameters are considered, the number of distinct price interactions that the trading system can conduct exceeds several thousand.

In another embodiment, a specific parameter configuration for each price interaction is delivered to the trading system by a small data set. The specific parameter configuration may be implemented through Extendible Markup Language XML, although other languages such as Hypertext Transfer Protocol (HTTP) may be used instead of XML. Because of this data-driven design, the trading system provided is easier to configure than existing auction and trading software. Another advantage provided by an embodiment of the invention is to that the trading system uses fewer components and modules than existing exchanges and auctions, especially when considering systems that can provide more than one type of price interaction over a network.

Another innovation provided is that the exchanges may be configured dynamically, before or during the time the exchange is in process.

Embodiments provide for a lot, identified as a group of identical items for sale. A trading engine represents the lot as an object carrying basic information about items for sale. The lot also may be associated with a strategy, containing essential parameters for defining the exchange type to be conducted for the lot. The strategy may be represented as an object that can be replaced or changed on the fly, without changing other lot data. As a result, each exchange performed for a lot may be instantaneously replaced in type, without resetting, rewriting, or otherwise greatly altering trading software. Such an ability can provide cost and time savings to users of dynamic pricing software who wish to switch between various dynamic pricing techniques in real-time, in response to changing market conditions or other information.

Another advantage provided under an embodiment of the invention is the ability to run multiple exchange and auction types concurrently, as a direct result of its lot-driven design. For example, the trading system may operate on hundreds or thousands of lots at the same time, giving each lot a time slice or moment of opportunity to conduct matching activities. Each lot is associated with a strategy object that is easily configurable in terms of a small set of relevant parameters. Because of this, each lot can conduct an exchange or auction type completely distinct from the others. As a result, the trading system provided can conduct hundreds of forward, reverse, exchange, and other dynamic price interactions concurrently—a unique capability far more efficient and versatile than older hard-coded techniques. This ability provides a solution that can deliver efficient exchange and auction types for each particular lot, which means better price efficiencies than are available with older solutions. Furthermore, relatively fewer hardware and software components may be implemented for conducting concurrent multiple types of exchange and auction types.

An embodiment of the invention provides for conducting a plurality of electronic exchanges over a network. Each exchange is conducted between a set of sellers and a set of bidders. The term set refers to one or more.

As used herein, the term exchange refers to a transaction environment between parties, and more specifically, between bidders and sellers. One example of an exchange is an auction. Another example of an exchange is a many-to-many marketplace. Each exchange includes traders as participants. The participants may be sellers or bidders. The sellers and bidders may either individuals, or programmed modules operating on terminals that access the network. Thus, an exchange may be automated through programming or manually operated by its participants.

In an embodiment, the set of sellers includes at least a first seller on a first terminal coupled to the network, and the set of bidders includes at least a first bidder on a second terminal coupled to the network. Each exchange is conducted to determine a transactional value of an item. The transactional value refers to a cost or a price, in terms of currency or other consideration. The item may be products, services and other exchangeable items. In one implementation, an item is a lot. Each lot may be represented in the trading system as an object.

In an embodiment, a plurality of requests are received by the exchange. Each request is made to initiate one of the plurality of exchanges. A plurality of selected parameters are identified with each of the plurality of requests. An instruction set is identified for each exchange based on the parameters selected with each of the requests. A parameter is a variable or setting that affects programming of the exchange. In particular, the parameters are settings or variables that determine the instruction set. The instruction set may comprise one or more instructions or rules.

For each exchange, the instruction set determines whether the set of sellers are to make ask offers for the set of bidders, and whether the set of bidders are to make bid offers for the set of sellers. Each ask offer and each bid offer specifies a proposed value for the item. Therefore, the instruction set determines if and possibly which offers are to be made by either the set of sellers or the set of bidders.

In an embodiment, each of the plurality of exchanges are conducted according to the instruction set determined by the plurality of parameters. Among other functions, the instruction set determine the transactional value of the item for each exchange.

In another embodiment, a plurality of exchanges may be conducted concurrently. For each of the plurality of exchanges, the plurality of parameters are designated a permissible origination for each of the offers, so that each offer is predetermined to be from the set of sellers or from the set of bidders. The plurality of parameters may designate a permissible origination for a response to at least one of the plurality of offers. The origination for the response designates a particular offer or set of offers as being from either the set of sellers or from the set of bidders. Each of the plurality of offers are received from the origination designated for that offer. The origination may also designate a particular trade for making the offer or acceptance. By making the origination permissable, the exchange is configured to allow select traders to make offer and acceptance. Each of the plurality of offers are provided to the origination designated for responding to that offer.

In still another embodiment, each of a plurality of exchanges may be executed to receive a sequence of offers. The sequence of offers includes at least a first offer from a seller or bidder. For each offer in the sequence of offers, the plurality of parameters designate a direction of increase of decrease for a value of a subsequent offer relative to a value of that offer in the sequence of offers.

The parameters for configuring exchanges may also be signaled to designate a size for the set of sellers and bidders. For example, users may signal parameters to configure an exchange to operate between one seller and many bidders, many sellers and one bidder, or many sellers to many bidders, as well as variations thereof.

The parameters for configuring exchanges may also be signaled to designate a settlement criteria for determining a transactional value of the item being exchanged. As used herein, the settlement criteria is used to select one or more offers for purpose of determining the transactional value of the item. In an embodiment, the settlement criteria is a selection process, implemented by one or more instructions, to identify an offer (from either a bidder or seller) that matches a criteria by another party accepting that offer. The criteria from the other party may also be an offer. The transactional value can then be determined using the selected offer.

In another embodiment, an exchange is conducted to determine a transactional value of an item offered for exchange by a first trader for a second trader. The first trader and the second trader may each be one of either a seller or a bidder. Each trader operates on a terminal coupled to a network. The trader may be an individual making manual entry for selecting parameters and/or making offers. The trader may also be a program or module that makes programmatic entries for selecting parameters and/or making offers. A plurality of selected parameters may be identified by at least one or both of the traders. One of the first trader and second trader is caused to submit a first offer over the network. An acceptance of the first offer is determinable. Until the first offer is accepted, the first trader and/or the second trader signal to enter a subsequent offer that is to replace the first offer. In an embodiment, a first parameter determines if the first offer is to be made by the first trader or the second trader. A second parameter determines if the second offer is to be made by the first trader or the second trade.

In other embodiments, a third parameter determines if the proposed value is to be equal to the transactional value when the open offer is accepted. A fourth parameter in the plurality of parameters determines if the subsequent value is to increase or decrease from the proposed value. Still another parameter may designate a duration of time for the subsequent offer to be entered. More or less parameters may be used in implementations and variations of the embodiment. In addition, different combinations of parameters may be implemented to configure the exchange.

In another embodiment, a transactional value is determined for an item offered for exchange by a first trader for a second trader. A first signal is received to initiate an exchange by at least one of the first trader and the second trader. A first plurality of parameters are identified from the first signal. Then, a first combination of instructions are determined from the identified parameters. The combination of instructions comprise rules, coding and methods that set the manner in which the exchange is to be conducted. Each combination of instructions may include one or more instructions. The exchange may be conducted according to the first combination of instructions. In response to receiving a second signal to alter the combination of instructions, a second plurality of parameters are identified based on the second signal. A second combination of instructions for conducting the exchange are determined from the second plurality of parameters. The exchange is then conducted according to the second combination of instructions. Thus, the exchange may have a new instruction set after it has been initiated.

An embodiment of the invention includes an engine for conducting a plurality of electronic exchanges over a network. Each of the plurality of exchanges are conducted to determine a transactional value of an item, such as specified in a lot or lot object. The engine is accessible to traders over a network such as the Internet. The engine includes a lot handler module and a match module. The lot handler module is configured to receive a request to initiate an exchange.

As used herein, a module includes a program, a subroutine, a portion of a program, a software component or a hardware component capable of performing a stated task or function. A module can exist on a hardware component such as a server independently of other modules, or a module can exist with other modules on the same server or client terminal, or within the same program.

The handler module identifies a selection of parameters from the request. The parameters may refer to settings, variables and identifiers for selecting specific instructions. In response to receiving the request, the lot handler module generates a lot object that specifies the item and associates one of a plurality of strategies with that lot object. The lot object includes an identification of an item for the exchange. Each of the plurality of strategies is specific to a corresponding selection of parameters. Subsequent to generating the lot object, the lot handler is configured to receive a plurality of offers specifying the lot object. Each of the plurality of offers are signaled by one of the plurality of traders. The strategy determines the transactional value of the item from at least one offer received during the exchange.

A match module is configured to identify a matched order from at least one of the plurality of offers being matched to another communication from one of the plurality of traders. The matched order may include a selected bid offer (from a bidder) matched to a selected ask offer (from a seller) according to a selection criteria. The matched offer may also include selected bid or ask offers that meet a criteria for acceptance by another party. To match offers, the match module compares a characteristic in one offer with a characteristic in another offer. The characteristic may be the price or value specified with the offer.

The plurality of strategies may comprise a combination of instructions that affect determination of the transactional value from receipt of a plurality of offers. In one embodiment, the strategy provides instructions designating an origination for each offer. Thus, the transactional value is affected by the variable that designates if new offers and price changes are to originate from sellers or bidders. In another embodiment, the strategy determines a methodology for computing, selecting, or otherwise determining the transactional value of the item from a plurality of offers received during the exchange. The term instructions or methodology refer to rules or other programming that set out a mechanism for determining a particular result.

Still, another embodiment may include a lot container module that maintains the plurality of lot objects and references each of the lot objects to the strategy for that lot object. The lot container module acts as a memory, cache or dynamic storage space for managing lot objects and associated data structures, for access and manipulation by other modules. The lot container module may cooperate with other modules to perform tasks such as prioritization, and ordering of lot objects according to scheduling.

In one embodiment, a lot container module maintains a plurality of lot objects. Each lot object is associated with a strategy object. Each of the strategy objects use a combination of instructions to affect determination of the transactional value from receipt of a plurality of offers.

B. Universal Trading System

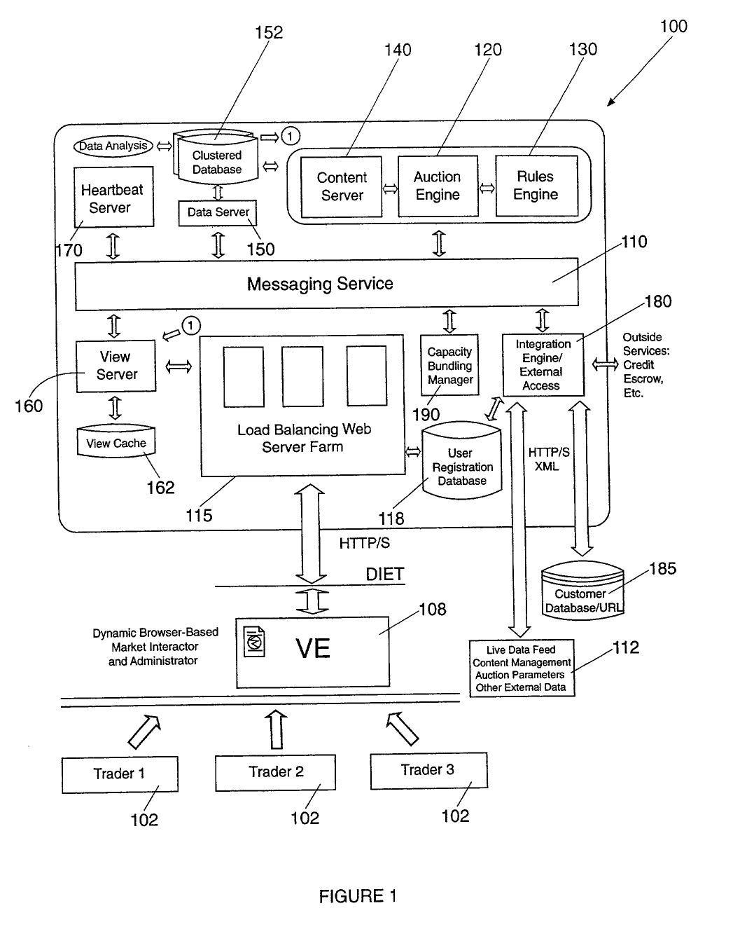

FIG. 1 illustrates a universal trading system 100 for use with an embodiment of the invention. The trading system 100 is accessible to a plurality of traders 102 over the network. The traders may be either bidders or sellers. The bidders provide bid offers for an item being offered for sale on a lot. The sellers provide the items. Each item may be a product or service. The trading system 100 may conduct exchanges where there is one seller for multiple bidders, as well as one or more bidders for multiple sellers.

In an embodiment, trading system 100 includes a messaging service 110 coupled to an exchange engine 120, a rule engine 130, and a content server 140. The messaging service is also coupled to a database server 150 and a view server 160. Other components of the system include a heartbeat server 170, an integration engine 180 and a capacity bundling manager 190. The components of trading system 100, including the interface with traders 102, are implemented with server farms 115.

The messaging service 110 may be a high speed system, such as a TIBCO RENDEZVOUS message bus. Preferably, all components that communicate through messaging service 110 use messages having a standard format. Other communication services could be used in place of this bus.

The traders 102 communicate with trading system 100 through a user-interface interface 108. The user-interface 108 is configured to enable traders to enter messages, offers and other communications for participating in exchanges. Traders 102 may access trading system 100 over a network such as the Internet. Each trader or user of trading system 100 may need to signal identification information to user database 118. For example, each trader may need a login and password.

In one embodiment, traders enter input rules through user-interface 108. The user-interface 108 may also enable controllers of a particular exchange to enter configuration parameters and variables. The user-interface 108 provides feedback for users, including traders 102 participating in an exchange. In an embodiment, a generalized data interface (such as for XML) may be used to transmit input rules from traders to rule engine 130. Templates and other user-interface features may be used to enable traders to generate a rule specifying an offer value. In similar fashion, the rule may be selected by the trader to be a specialized formula or function to be stored and managed by rule engine 130. In an embodiment, user-interface 108 may be implemented as described in U.S. patent application Ser. No. 09/782,932 to Moshel et al., entitled Method and Apparatus for Graphical Representation of Real-Time Data,” filed Feb. 13, 2001, and incorporated by reference herein.

The exchange engine 120 maintains a state machine that moves offers from traders using the trading system 100. The offers may be in the form of bids (offers from bidders) and asks (offers from sellers) through one or more offer states. Using one implementation, the offer states include open offers, pending offers, accepted offers, confirmed offers, and rejected offers. The exchange engine 120 may also execute instructions or rule sets for conducing selected exchanges and auctions. The exchange engine 120 configures instructions for conducting exchanges according to certain characteristics by receiving parameters and other small sets of variables. The exchange engine 120 may be remotely accessed (using, for example, an XML message) to include the configurations. The offers for each lot may be stored in two sorted binary trees (one for bids and one for asks). As a new bid or ask arrives it is efficiently processed and placed in this tree. Accepted offers are passed to the integration engine 180 to be confirmed or rejected.

The rule engine 130 is used to set prices for exchange engine 120. The rule engine 130 may alternatively be referred to as a pricing engine, as it provides offers in the form of prices to exchange engine 120. The rule engine 130 stores input from traders of trading system 100. Each input rule comprises one or more rules for programmatically inputting offers into trading system 100. The input rules are decoded and implemented by rule engine 130. In an embodiment, traders (bidders and sellers) may submit input rules that are received and parsed by rule engine 130. The rule engine 130 identifies one or more offers that are to be submitted for a particular exchange. The identified offers are forwarded to exchange engine 120. Preferably, rule engine 130 passes exchange engine 120 qualitative information as well as the price of the offer. In one example, rule engine 130 passes exchange engine 120 a “score” of an offer presented to the trading system 100 as a rule. The score is determined by performing an evaluation upon multiple, weighted parameters. In the simplest case, price is the only variable used to create a score, but the number and types of variables used is extensible. In another case, the certainty/uncertainty that an offer may be acted upon by the offeror may affect the score, in addition to the value of the offer.

The rule engine 130 may be instructed by an input rule to generate new offers periodically. Each offer may submit a new value of price for consideration in response to an occurrence or event in the market. For example, a rule may generate an offer for a particular number of units of a lot, at a price (or multi-parameter offer) determined by the rule. A rule interface allows a class to define the next price and delay until the next offer, based on input about the state of an ongoing exchange. In one implementation, rule engine 130 maintains a binary tree of objects called “RuleContext” objects, sorted in the order in which their next offers will generated. The RuleContext objects store the lot, trader, initial price, units, and other data about a rule, and is also a container for the rule itself which governs how its price changes over time. The rule engine 130 wakes up periodically and scans the rule list for rules that need to be executed. It then executes those rules, calculates their new position in the rule list based on their next execution time and reinserts the rules in the list. Sellers or buyers may specify rules for particular lots, and may also update their rules in real time. Preferably, these rules are encoded in an XML data format (or other standardized data format) and are specific for a particular exchange. Each input rule may be forwarded to rule engine 130. An additional feature of exchange engine 120 and rule engine 130 is that the rules may respond to a real-time data input, to perform matches on a synchronous or asynchronous basis with respect to this input.

The content server 140 caches and serves lots, offers, rules and traders to other back end components, including rule engine 130 and exchange engine 120. The content server 140 keeps objects in an LRU cache or hash table. As will be further described, each exchange may be associated with a plurality of data objects, including a lot object and a strategy object. The content server 140 handles messages to put single objects, fetch single objects, and fetch lists of objects using an identification. All objects are mapped by a unique identification (ID) generated by the database to the master copy of the object. If an object is not referenced, it may drop out of the LRU cache. Objects are then re-fetched from the data server on demand.

The database server 150 is coupled to database 152. The database 152 stores lots, offers, rules, traders, offer trees etc. The database server 150 is a conduit between messaging service 120 and the database 152. The database server 152 handles storing, fetching and updating objects to be persisted in database 152 (lots, offers, rules, traders, tree nodes), as well as translating between object formats and the schema of database 152.

The view server 160 accesses a view cache 162 to messaging service 120. The exchange objects in view cache 162 contain information about active lots, those in which there is current bidding activity. The view cache 162 includes category, lot, rule, offer, order, and trader information. In this manner, view server 160 acts as an interface between the messaging back end and the web server front end. The view server 160 translates messages from messaging service 120 into an efficient in-memory cache of exchange objects (lot objects and strategy objects) for view cache 162.

In this way, the view server 160 can access view cache 162 to enable traders to view exchange objects during the exchange. For example, view server 160 may receive a request for a piece of data, such as the current ask price for a given lot item. The view server 160 may return the data from view cache 162. The view cache 162 is integrated with view server 160, so that view server 160 may avoid accessing separate database. As a result, view server 160 is more efficient in retrieving exchange objects in response to requests.

The view server 160 may also be accessible to database 152. If a request pertains to historical data, e.g. the bidding history of a closed lot, view server 160 fetches the requested information from database 152. In addition to the object caches, view server 160 may also maintains a time-ordered message queue. The queue is used to feed live streaming data to client applets. An applet will poll view server 160 periodically (e.g. once a second) for any updates to offer or order activity on a given lot since a given time. The view server 160 handles these requests efficiently by returning the list of messages from its queue received since the last client request. It also returns the current time, which the client passes in its subsequent request.

The heartbeat server 170 knows what other components should reside on the backbone. The heartbeat server sends an initialization message to all components and waits for an answer. It next sends a run message, followed by periodic status messages every few seconds. If a component does not answer the status message, it is assumed dead, and a stop message is sent to all components to allow the system to save any necessary data or state information. This is followed by run messages to restart the system.

The heartbeat server controls the recovery framework. When a machine or process fails the heartbeat server can gracefully halt the entire system and request the components to restart. Recovery is predicated upon three features of our engine: (1) Every component has the ability to initialize itself when it starts up; (2) the heartbeat server manages the other components; and (3) the database is the ultimate repository for recovery data.

The integration engine 180 is responsible for communication between trading system 100 and the systems of traders. The integration engine 180 maintains a list of records in customer database 185. A record providing customer specific information exists for individual traders. In particular, integration engine 180 maintains records for sellers who access the trading system 100 to offer goods and services. These records may include, depending upon the partner/customer: a) an inventory URL, b) a transaction URL, and c)an authentication URL.

The inventory URL is periodically polled by integration engine 180 for updates to the seller's inventory. This URL may have data encoded in a standard format such as XML, although XML is not necessary to accomplish this result. An initialization data file is polled at startup time to define the initial category tree, list of lots, exchange type, and the rules/instructions that will apply to the exchange. A second file is polled on a regular basis for updates to the tree; updates include the ability to add nodes, add lots, delete (close) lots, and possibly to edit open lots (change the ask price or number of units, or add an ask to a lot). Either file can be polled at defined intervals, depending upon the needs of the trader.

The transaction URL is for signaling a transition request to an appropriate trader. When the exchange engine generates an accepted offer pending confirmation, it is passed to integration engine 180 so that a transaction request may be sent to the appropriate trader. The request includes the trader's lot ID, the user ID, the number of units, and the closing price. Depending upon the trader's needs, embodiments of the invention may conduct elemental segments of the transaction including removing the items from a database, and charging another trader's credit card (such as for a winning bidder). If this operation succeeds a “confirmed” message is passed back to the exchange engine 120; otherwise a “rejected” message is returned with an explanation. In some cases, a market operator and a customer/partner may be the same and can both perform transactions. In other configurations, the partner/customer may be administering an “exchange” in which other entities perform the actual sales.

The authentication URL enables a trader to use a uniquely encoded user ID that is passed it to the trading system 100 over the network. In one implementation, the ID is stored in a cookie. When a transaction is generated, the user ID is passed back to the transaction URL to indicate the user making the bid. Both bidders and sellers have ID's. The seller ID's are specified in the “Owner” sections of the XML data, and are granted privileges to conduct and monitor auctions for particular categories.

The integration engine 180 also provides a standardized application program interface (API) to access messaging 110 over a network such as the Internet. This can be useful in a variety of applications. One notable application uses a feature of a Dynamic Live Input Feed 112, in which continuously varying data is delivered to the exchange engine 120 through the integration engine 180. The feed 112 allows offers to be updated in real time with respect to arbitrary external data. The feed may be incorporated as a portion or module of rule engine 130.

The capacity manager 190 performs load balancing between instantiations of the exchange engine 120. Embodiments of the invention have the capability for dynamically starting new exchange engine 120 processes, and allocating different lots to them based upon demand. These processes for exchange engine 120 may be fully distributed among different machines or over a network. This gives us variable capacity and fail-safe capability.

The capacity manager 190 also has the ability to facilitate “bundled” transactions in which an offer is made for more than one item (such as a bid of $1000 for an airline reservation, hotel room, and rental car).

C. Parameters/Variables for Configuring Exchanges

Embodiments of the invention abstract common exchange types into a smaller set of elemental parameters. The embodiment described below discusses 22 parameters, each of which configure or otherwise designate a characteristic of an exchange that affects determination of pricing and transactional values for lot items. Other embodiments of the invention may implement a greater or lesser number of parameters to configure exchanges.

At the most basic level, each exchange involves a pricing interaction between at least one buyer and at least one seller. One function or purpose of the exchange is to determine a transactional value for an item being exchanged between a buyer and a seller. Each exchange may be conducted by a plurality of traders. The plurality of traders may be divided into a set of sellers and a set of bidders. Each set of sellers or bidders may include one or more participants (bidders or sellers).

Depending on the type of exchange, there may be offers received from the bidders, the sellers, or a combination of the bidders and sellers. Thus, an embodiment of the invention provides two elemental parameters, MAX_BIDS and MAX_ASKS, which combine to control the number of buyers and sellers in an auction. In a normal “forward” auction, for example, the number of sellers (MAX_ASKS) is set to 1, while MAX_BIDS is set to “no limit” (signified, in the parameters given here, by a value of “0”). In a many to many exchange, both MAX_BIDS and MAX_ASKS would be set to “0”, signifying that there can be unlimited numbers of buyers and sellers.

1. The Strategy Variable

An embodiment of the invention assumes that each exchange type is built upon one of three basic “strategies”. These three types are: General Exchange, Dutch Auction, and Japanese Auction. The three exchange strategies may be further broken down into variations and combinations of these exchanges. The trading system 100 may be receive parameters from operators to implement exchanges for traders using one or more of the many different strategies possible.

In the General Exchange type, a price determination for each order is made between individual buyers and sellers. The transactional value of an item offered in the exchange is determined during a “match state”, which can occur one or more times for each exchange. A more complete explanation of when these matching states occur is given below, accompanying the explanation of the variable “MATCH_TRIGGER”.

During a match state of a General Exchange, an embodiment of the invention may determine a transactional value of an item by matching the lowest ask (seller) with the highest bid (buyer). For example, the offers might be $56 for the ask and $62 for the bid. Depending on other variables used (see e.g. the variable SETTLEMENT_POLICY), the transactional value of the item might be (a) set to be equal to the ask offer of $56 (designated by the variable OP_PAY_ASK_PRICE); (b) set to be equal to the bid offer of $62 (designated by a variable OP_PAY_BID_PRICE); or (c) set to be equal to an average of the bid offer and the ask offer, or $59 (designated by a variable OP_PAY_AVERAGE).

As discussed above, the distinguishing feature of the General Exchange strategy is that each buyer is matched up against one seller at a time. In contrast, the Dutch Auction implements a strategy in which a group of bids will qualify for the seller, and the price paid will be calculated considering the prices of the group. In one implementation, a value of one acceptable offer is used as the transactional value for other acceptable offers from. As an example, a plurality of bidders may submit winning bids, and the selected transactional value for each of the qualifying bidders is designated to be the value of the lowest qualifying offer. One common example of such Dutch Auction is select Initial Public Offerings on public stock exchanges, in which the highest bidders at the end of the price either pay the highest losing price (designated by the variable OP_PAY_HIGHEST_LOSING) or the lowest winning price (designated by the variable OP_PAY_LOWEST_WINNING). In other examples for a Dutch Auction strategy, all the bids will either pay the lowest winning offer (designated by the variable OP_PAY_LOW_WINNING); or the highest losing offers (designated by the variable OP_PAY_HIGH_LOSING). As with all exchanges, there are many variations to the Dutch Auction strategy. For example, the Dutch Auction can be implemented with more than one seller (referred to as “Exchange Dutch”; its configuration and operation is more fully described below.).

In the Japanese Auction strategy, a proposed price for the item is raised for buyers to match. The seller may continuously raise prices for the bidders to match, until there is only one bidder left for each item being offered in the exchange. One common feature of the Japanese Auction strategy is a wait period after when the proposed transactional value of the item is increased. For example, the seller may raise his or her price to allow the buyers to increase their bids. After a combination of one or more parameters designate the type of exchange as being the Japanese Auction strategy, another parameter may be identified by the trading engine as designating the wait period (e.g. variable BID_QUIET_PERIOD). The wait period is configurable to allow for offers from sellers to be subject to wait periods before the match sate is entered. Thus the variable ASK_QUIET_PERIOD is also available. If, for example, both wait period variables (BID_QUIET_PERIOD and ASK_QUIET_PERIOD) are both set to zero, there is no quiet period. A match state may be triggered upon expiration of a wait period.

While the concept of wait periods has been discussed for use with Japanese Auction strategies, the two wait periods may be added to a variety of different auction types in order to elicit certain effects, such as an extension of the period within which offers can be made. The interoperability of the wait periods with other exchange strategies is an example of the unique configurations offered by embodiments of the invention.

Embodiments of the invention allow for the trading system to be configured to operate an exchange that implements the concept of wait periods. The exchange type is referred to herein as a Dual Wait Exchange. In the Dual Wait Exchange, both bid and ask quiet periods are set to different times. For example, in an exchange environment with three sellers and unlimited buyers, a market operator might wish to set the ASK_QUIET_PERIOD (the period of time after a seller changes his or her ask) to a longer time than the BID_QUIET_PERIOD (the period of time allotted for bidders to change the last bid offer). If ASK_QUIET_PERIOD is set to one hour, and BID_QUIET_PERIOD is set to 10 minutes, a match state will not occur until either both one hour after the last ask offer is submitted (thereby changing the ask offer), and 10 minutes after the last bid offer is submitted (thereby changing the last bid offer). This new exchange type can be useful if a limited number of sellers rarely change their prices and therefore want a longer time (1 hour) to respond to each others' price changes, and if buyers are more active and a time period of 10 minutes is chosen for them (activity by the buyers might preclude a match if a longer period were used).

2. Settlement Policy

Each exchange strategy includes a settlement policy, in which the transactional value of the item of the exchange is determined from one or more offers submitted by traders. A settlement policy determines the transactional value of the item for an exchange based on accepted offers (bid and ask) that were received during the exchange. The settlement policy may be implemented to select offers for matching during a match state. The settlement policy may also determine the transactional value of the item based on the selected offer.

Embodiments of the invention implement parameters to configure settlement policies for each exchange. The selection of parameters indicating the settlement policy may be made by one or more parties in control of the exchange. The settlement policy determines the outcome of transactional value from the offers (bid and/or ask received). Thus, settlement policy variable can be used within the above exchange strategies to produce a variety of auction behaviors.

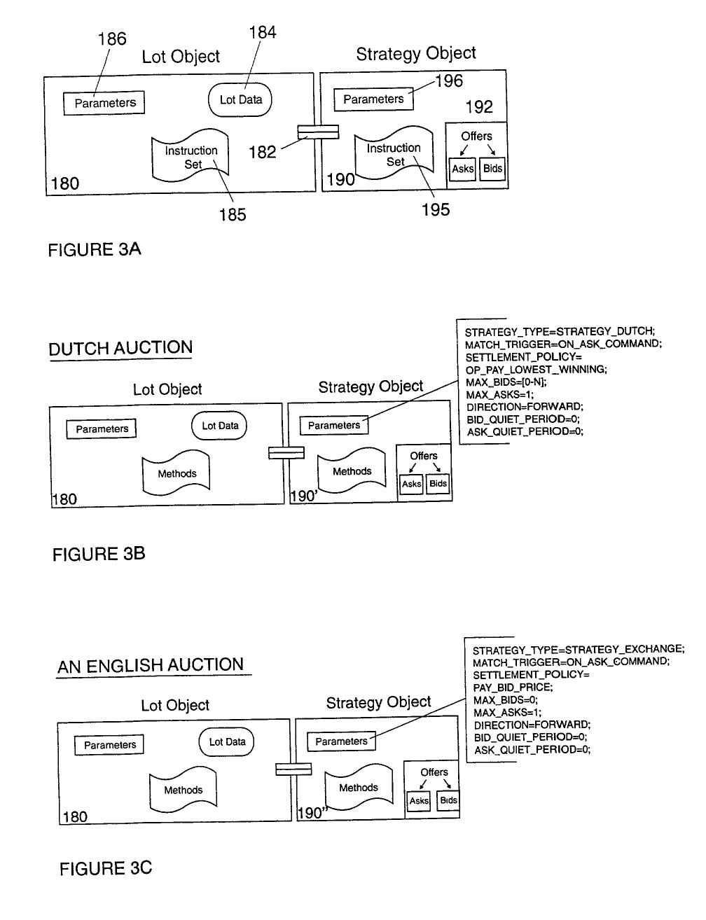

In an embodiment, the basic variables for implementing a selected settlement policy are: a) transactional value is the ask price (labeled OP_PAY_ASK_PRICE); b) transactional value is the bid price (labeled OP_PAY_BID_PRICE); c) the transactional value is the either the bid offer or the ask offer that is first in time during or after a designated time period (labeled OP_PAY_FIRST_IN_TIME); d) the transactional value is the either the bid offer or the ask offer that is last in time during or after a designated time period (labeled OP_PAY_LAST_IN_TIME); e) the transactional value is all bid offers exceeding an ask offer (labeled OP_PAY_OWN); f) transactional value for each winning bid offer is determined from a value of the next lowest offer (labeled OP_PAY_STAIRSTEP); g) the transactional value is the value of the lowest losing offer (labeled OP_PAY_LOWEST_LOSING); h) the transactional value is the value of the lowest winning offer (labeled OP_PAY_LOWEST_WINNING); i) the transactional value is the value of the highest losing offer (labeled OP_PAY_HIGHEST_LOSING); j) the transactional value is the value of the highest winning offer (labeled OP_PAY_HIGHEST_WINNING); and k) the transactional value is the value of an average of offers received from select traders (labeled OP_PAY_AVERAGE). A more detailed description of some of the types of exchanges possible with embodiments of the invention are provided with FIGS. 3A-3C.

3. Match Triggers

Embodiments of the invention provide a variety of ways to trigger a settlement or “match” event. The occurrence of the match event causes the transactional value of the item to be determined based on pending offers, as dictated by the settlement policy. In other words, the match state may be triggered to cause the settlement policy to be implemented. One or more parameters may be specified to the exchange to dictate the triggering event or condition by which a match state is initiated.

In one implementation of an exchange, a match event is triggered every time an offer (bid or ask) is made (labeled by the parameter ON_OFFER). In variations, the match state may be triggered by each bid offer (ON_BID) or on each ask offer (ON_ASK). In other variations, a match is triggered at the expiration time for the participants of the exchange to make a bid or ask offer (labeled by the parameter ON_OFFER_COMMAND), expiration of time for the sellers making an ask offer (labeled by the parameter ON_ASK_COMMAND), or by the expiration of time for the bidders making a bid offer (labeled by ON_BID_COMMAND).

Alternatively, each exchange may be conducted to trigger matches on a time-slice basis, such as once every hour for 10 hours (labeled by ON_TIME_CONTROL). Further explanation of time control match triggers is provided below. Still further, each exchange may be set to trigger matches on occurrence of an event (labeled by ON_EXTERNAL_EVENT).

The descriptions of various exchanges given below, illustrate various applications of these match triggers. As a simple example, in the ordinary English forward auction, the match trigger is ON_ASK_COMMAND because a match should occur after the ask expires, that is, after the deadline for the auction has passed.

Embodiments of the invention may be executed to use defaults for the parameters, including the match state trigger. The defaults for the match state trigger may be according to the MATCH_TRIGGER variable as well as on a “time-slice” basis.

Another type of exchange provided by an embodiment of the invention is based on external events. One or more configuration parameters may be used to configure such an exchange. In an embodiment, a parameter labeled ON_EXTERNAL_EVENT allows an outside data feed to trigger a match state each time this data feed is changed. One example of such outside events is instantaneous updates of Treasury Bill notes. This allows a synchronous marketplace that is tied to any number of outside data feeds. This feature is an example of diverse configurations available under embodiments of the invention.

4. Direction of Exchange

Embodiments of the invention allow for configuring a direction for each exchange being conducted by the trading system. In particular, a “direction” parameter may be used to configure auction type exchanges, enabling diverse marketplaces to be derived from one trading system.

Traditionally, most auctions and exchanges come in forward and reverse forms. The traditional forward auction has a single seller and the buyers advance in price toward the seller. The traditional reverse auction is driven by a single buyer and the asking prices of the sellers drop in competition for that buyer's business. By using parameters to create configurable exchanges, the distinction between bidders and sellers amongst the traders using each system are minimized. The parameterization enables, for example, each forward auction can be changed to a reverse auction by simply setting the “forward” or “reverse” settings of a variable corresponding to the direction of the exchange.

A variable corresponding to direction may have three selectable settings: FORWARD, REVERSE, and NEUTRAL. Most basic exchange strategies are run in neutral, within which no particular preference is given to buyers over sellers. However, embodiments of the invention can operate in forward or reverse under any strategy, including the General Exchange. If an exchange is run in forward, preference is given to satisfying the constraints of the sellers before the constraints of the buyers.

5. Time Parameters

The trading system 100 may be configured with use of time-parameters. The time parameters for use with embodiments of the invention include: (a) a parameter that indicates to the exchange engine 120 when an exchange should begin (labeled as AUCTION_START_TIME); (b) parameters to indicate when a match state will be triggered (labeled herein as MATCH_TIME_INTERVAL, MATCH_REPETITIONS, ACTIVE_TIME_INTERVAL); and (c) parameters to indicate cycles for an exchange to be conduted (CYCLE_TIME_INTERVAL).

The parameter AUCTION_START_TIME may be specified in absolute time units (e.g. seconds) to designate when an exchange should begin. This parameter may be used to configure any type of exchange. Once an exchange begins, it is in an “active state” within which matches can occur.

Parameters that indicate when a match state will be triggered operate on a time-slice basis, (e.g., every 1 second or every 1 hour). As previously described, match states can alternatively (or as a supplement) be triggered by the MATCH_TRIGGER variable, independently of the time variables.

The frequency of the time-slice states is set by the variables MATCH_TIME_INTERVAL and MATCH_REPETITIONS. MATCH_TIME_INTERVAL is in time units, and indicates how often a match state should occur. For example, if MATCH_TIME_INTERVAL is set to 1 second, a match state occurs every 1 second. MATCH_REPETITION states how many times a match state will occur. Thus, if MATCH_TIME_INTERVAL is equal to 1 second and MATCH_REPETITION is equal to 3600, there will be 3600 match states which will occur at a rate of one per second. This is in addition to any match states that happen to be triggered by the MATCH_TRIGGER variable. As another example, if MATCH_TIME_INTERVAL were set to 1 hour, and MATCH_REPETITIONS were 5, a match state would occur once per hour for five hours.

If the market operator wants to run an auction that conducts matches only on a time-slice basis (and does not respond to particular commands, such as ON_BID) the variable MATCH_TRIGGER should be set to ON_TIME_CONTROL. If the market operator wants to turn off time-slice matching, MATCH_TIME_INTERVAL and MATCH_REPETITIONS should both be set to zero. In that case, match states will be triggered by the MATCH_TRIGGER variable only.

Exchange engine 120 allows each exchange to be switched from the active state to an inactive state, including a hiatus or termination. An exchange can be run so that trades are possible during certain time periods. For example, an exchange may be active during business hours, but inactive at night (like the NYSE, for example). To do this, certain parameters must be set. First, ACTIVE_TIME_INTERVAL must be non-zero and set to a time quantity. This indicates the length of the active state after AUCTION_START_TIME is reached. The variable CYCLE_TIME_INTERVAL will be used to represent the whole time period that will be repeated. Thus, if ACTIVE_TIME_INTERVAL is set to 18 hours, and CYCLE_TIME_INTERVAL is set to 24 hours, the exchange will begin at the start time, run for 18 hours in an active state, and continue in an inactive state until 24 total hours have passed (inactive for a total of 6 hours) and the cycle will begin again. The exchange engine 120 implements this cyclical functionality by moving AUCTION_START_TIME to the end of the current CYCLE_TIME_INTERVAL at the end of the current ACTIVE_TIME_INTERVAL.

It should be noted that ACTIVE_TIME_INTERVAL must be less than CYCLE_TIME_INTERVAL, or no matching will occur.

6. Lot Sizes

Variables designating lot sizes (labeled herein as MinimumLotUnits and MaximumLotUnits) describe the minimum and maximum number of individual units that can be cleared by one order in a particular offer. This is globally enforced across all buyers and sellers in the lot. These variables might be set, for instance, if a market operator wanted to control the sale rate of items in an auction.

7. Number of Auctions/Price Interactions Offered

The trading system 100 may operate multiple exchanges concurrently. By varying the strategy parameters listed above, trading system 100 may operate approximately 652 exchanges, each having a distinct configurations and covering over 26 well-defined exchange types. If the options for Sealed_Bid, Sealed_Ask, Anonymous_Bid, and Anonymous_Ask are included (approximately a 16-fold increase in the number of possible configurations) the exchange configuration number is approximately 10,432. In addition, the variables MinimumLotUnits, MaximumLotUnits, MinimumOfferUnits, MaximumOfferUnits, and IncrementUnits add additional configuration options to the traders that access the trading system 100.

The variables designating an offer size may be specific to the bidders, sellers or both. One parameter (labeled as MinimumOfferUnits) may designate the minimum number of units a particular offer is willing to accept. Another parameter (labeled as MaximumOfferUnits) may designate the maximum number of units a particular offer is willing to accept. Another parameter (labeled as IncrementUnits) designates the multiples of items to be sold in each lot. If, for example, IncrementUnits is non-zero, and MinimumOfferUnits is zero, acceptable unit totals may be multiples of IncrementUnits. For example, if IncrementUnits is set to 3, acceptable unit totals are 3, 6, 9, etc. If MinimumOfferUnits is non-zero, any matching quantities after the MinimumOfferUnits must be a multiple of IncrementUnits. For example, if MinimumOfferUnits is 4 and increment units is 5, acceptable orders would be 4, 9, 14, etc.

D. Implementations of Exchange Configuration

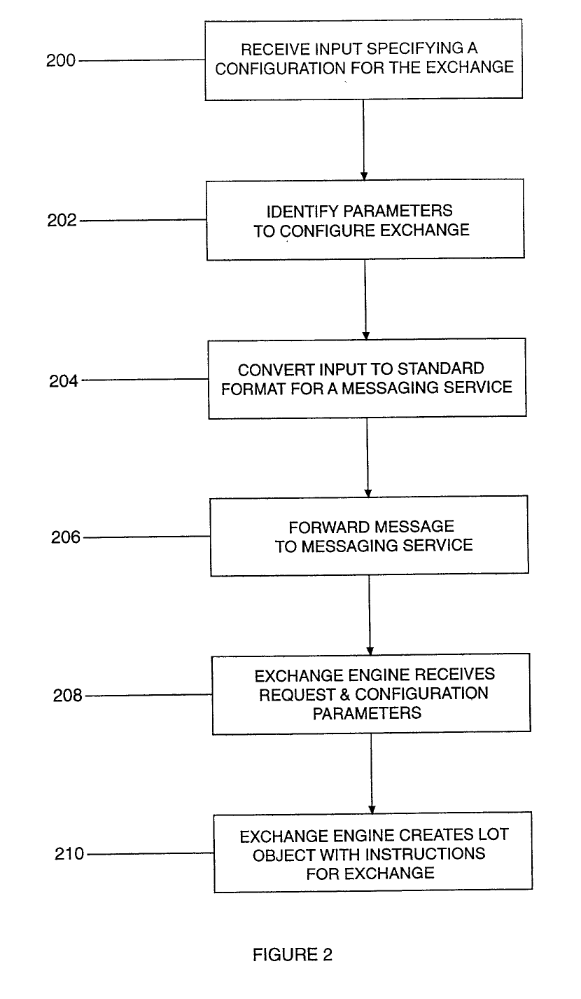

FIG. 2 illustrates a process for configuring an exchange using the trading system 100, under an embodiment of the invention. In step 200, an input is received specifying a configuration for the exchange. The input may be received from a controller of the exchange. The controller may correspond to one of the participating traders, such as the seller of an item. The configuration may comprise one or more parameters, where each parameter is intended to select one or more features of the exchange. The input may be in the form of an XML data structure. Either a seller or a bidder may request to initiate an exchange.

In step 202, the input from the trader requesting the exchange is parsed to identify one or more parameters for configuring the exchange. In an embodiment, integration engine 180 parses the input to identify the parameters.

In step 204, the input is converted to a standard data format for a messaging service. In an embodiment, this step is also performed by the integration engine 180.

The message is forwarded to the exchange engine 120. In step 206, the message is first signaled to messaging service 110 before being forwarded to exchange engine 120. The exchange engine 120 listens for messages from messaging service 110.

In step 208, exchange engine 120 receives the request for the new exchange, including the parameters specified in the input. The request may be signaled as a message from messaging service 110. The exchange engine 120 may listen for messages carrying requests for new exchanges, as well as parameters for configuring the exchanges.

In step 210, exchange engine 120 creates a new lot object in response to receiving the message. The lot object may be initialized with data gained from the message signaled by messaging service 110. The construction of the lot object for the exchange is further detailed with FIGS. 3A-3C.

FIGS. 3A-3C illustrate data structures for implementing exchanges on trading system 100. Each exchange provides an item for exchange between a set of sellers and a set of bidders. In an embodiment, each exchange corresponds to a lot object 180. The lot object 180 is associated with a strategy object 190. The lot object 180 and the strategy object 190 combine to define the exchange, including the rules and instructions used to carry out the exchange.

When lot information is passed to the exchange engine 120 (see FIG. 1) that information is stored in a standardized, object-oriented data format. The lot object 180 includes a pointer 182 to the associated strategy object 190. The strategy object 190, in turn, contains pointers to ordered lists 192 comprising bid and ask offers. The offers may be in a variety of data structures. In one embodiment, a balanced binary tree is used to order the offers for fast look-up. Each offer is listed as an object in one of the binary trees. The offer object in these trees also contains data fields (or other multi-parameter fields) specifying a value. The value of each offer may be a price or cost. Alternatively, the value of each offer may be a “score” calculated based on either price or on other parameters in a multi-parametric exchange.

The lot object 180 and the strategy object 190 may also include a plurality of parameters 186, 196. The plurality of parameters 196 are received from one or more traders or controllers of the exchange. Preferably, the trader (seller or bidder) requesting initiation of the exchange selects the parameters and/or parameter settings. The selections may be signaled with the request to initiate the exchange.

The lot object 180 and the strategy object 190 contain within them appropriate instructions sets 185, 195 (including methods and functions) in order to carry out match state operations such as were described above (the Dutch matching algorithm, Vickrey, etc). The instruction sets 185, 195 are specific to the plurality of parameters 186, 196. The instruction sets 185, 195 are preferable portions of an overall combination of instructions for that exchange. These instruction sets 185, 195 can also insert a new offer into its appropriate position in the offer lists. In addition, the instruction sets 185, 195 can determine whether a match state should take place, and if so, are able to return pairs of bids and asks that will constitute trades or transactions after the match procedure.

The strategy variables discussed above (STRATEGY_TYPE, MATCH_TRIGGER, SETTLEMENT_POLICY, DIRECTION, MAX_BIDS, MAX_ASKS, BID_QUIET_PERIOD, ASK_QUIET_PERIOD, AUCTION_START_TIME, MATCH_TIME_INTERVAL, MATCH_REPETITIONS, ACTIVE_TIME_INTERVAL and CYCLE_TIME_INTERVAL) are examples of configuration information that can be stored in the strategy object. Variables (MinimumLotUnits and MaximumLotUnits) representing the minimum and maximum units that may be traded by one offer in one match state in this lot are stored in the lot object. In one implementation, each offer in the strategy object 190 stores three variables (MinimumOfferUnits, MaximumOfferUnits and IncrementUnits). The lot object 180 may also lot data 184, which may include textual information describing each lot. Each of the data objects in lot object 180 may be assigned a unique Lot Identification, which may be stored in lot data 184.

By use of object-oriented representation for exchanges, each lot object 180 and the associated strategy object 190 defines the type of exchange that should run for each lot. Changing exchange types, therefore, is simply a matter of replacing the strategy object 190 with a new strategy object (or changing the variable fields in the strategy object). Each strategy object 190 is a function of the parameters, which form a combination of instructions.

In an embodiment, changes to exchange types can be made on-the-fly without changing any of the other lot parameters. This allows trading system 100 to be configurable for instantaneous switching between exchange types. It also should be noted that the architecture of trading system 100 allows strategy object 190 to be changed or altered, so as to conform to the messages received from the lot object 180. Thus, although embodiments of the invention discuss three base strategies (Exchange, Dutch, and Japanese), other strategies could be added or the base strategies could be implemented in different ways.

FIG. 3B illustrates lot object 180 and strategy object 190′ for conducting a Dutch Auction type exchange, under an embodiment of the invention. The strategy object 190′ is configured with inclusion and/or settings of the parameters 196 to conduct the Dutch Auction. The configuration of the strategy object 190′, and specifically the parameters used, determines the instruction sets 185, 195. In this example, the strategy type is set to be a Dutch style exchange (STRATEGY_TYPE=STRATEGY_DUTCH). The triggering event for starting the match state is set to occur upon receiving an ask command, corresponding when the exchange is over (MATCH_TRIGGER=ON_ASK_COMMAND). The settlement policy is set so that the transactional value is the value of the lowest winning bid (SETTLEMENT_POLICY=OP_PAY_LOWEST_WINING). The size of the sellers is set to one for the Dutch Auction (MAX_ASKS-1). The size of the set of bidders is set to be a selectable maximum number (n) (MAX_BIDS=[0−N]), or may be set to unlimited (MAX_BIDS=[0]). The direction parameter is set to FORWARD, providing for more bidders than sellers. There is no quiet period, ether for the seller or bidder (BID_QUIET_PERIOD=0; ASK_QUIET_PERIOD=0).

FIG. 3C illustrates lot object 180 and strategy object 190″ for conducting an English type auction. The exchange type is designated as General Exchange (STRATEGY_TYPE=STRATEGY_EXCHANGE). The match state trigger is set for an ask command, meaning by expiration of time (MATCH_TRIGGER=ON_ASK_COMMAND). The settlement policy is designated to pay the highest bidder (SETTLEMENT_POLICY=PAY_BID_PRICE). The size of the set of bidders is set to be a defined plurality, but there is only one seller in the set of sellers (MAX_BIDS=[0−N]; MAX_ASKS=1). The direction of the exchange is forward (DIRECTION=FORWARD. There is no quiet period, ether for the seller or bidder (BID_QUIET_PERIOD=0; ASK_QUIET_PERIOD=0).

Embodiments of the invention enable lot object 180 to be associated with strategy object 190′, then switched to strategy object 190″ on request. Therefore, a trader may select to make the exchange underway go from having characteristics of one type of exchange to characteristics of another type of exchange. The change may be made through reselection of parameters used for configuring instruction sets 185, 195. For example, the reselection enables the trader to convert the exchange from the Dutch Auction type exchange shown in FIG. 3B to the English Exchange shown in FIG. 3C. Preferably, only the trader requesting or designated as being able to control the exchange specifies parameters for configuring and reconfiguring exchanges.

The parameters entered for purpose of configuring exchanges may be stored and implemented with different data objects. The instruction sets derived from the parameters may be stored with the corresponding selection of parameters. In one embodiment, the strategy object 190 stores parameters (and corresponding instructions for) strategy type, match triggers, settlement policy, exchange directions and other parameters listed below. The lot objects store parameters (and corresponding instructions for) maximum and minimum lot sizes. In addition, some parameters provided for configuring exchanges may be provided with offers submitted from the traders. Other parameters for configuring exchanges may be implemented as client-side features. The following are reviews of exemplary parameters, under an embodiment of the invention.

Parameters for Strategy Object:

STRATEGY_TYPE

{
STRATEGY_EXCHANGE
STRATEGY_DUTCH
STRATEGY_JAPANESE
};

MATCH_TRIGGER

| { | |
|---|---|
| ON_OFFER | |
| ON_BID | |
| ON_ASK | |
| ON_EXTERNAL_EVENT | //Use for Live Data Feed |

ON_OFFER_COMMAND
ON_BID_COMMAND
ON_ASK_COMMAND
ON_TIME_CONTROL
};

SETTLEMENT_POLICY

| { | |
|---|---|
| OP_DEFAULT | |
| OP_PAY_ASK_PRICE | |
| OP_PAY_BID_PRICE | |
| OP_PAY_FIRST_N_TIME | |
| OP_PAY_LAST_IN_TIME | |
| OP_PAY_OWN | |
| OP_PAY_STAIRSTEP | //Vickrey extension to N successful |

buyers/sellers
OP_PAY_LOWEST_LOSING
OP_PAY_LOWEST_WINNING
OP_PAY_HIGHEST_LOSING
OP_PAY_HIGHEST_WINNING
OP_PAY_AVERAGE
};

DIRECTION

| { | |
|---|---|
| NEUTRAL | //Use Neutral for exchange mode |
| FORWARD | |
| REVERSE | |
| }; | |

| | |
|---|---|
| MAX_BIDS [0-N]; | //“0” is an unlimited number of bids |
| MAX_ASKS [0-N]; | //“0” is an unlimited number of asks |
| BID_QUIET_PERIOD [N]; | //In time units. Set to zero if no bid |
| | //bid quiet period |
| ASK_QUIET_PERIOD [N]; | //In time units. Set to zero if no |
| | // ask quiet period |
| AUCTION_START_TIME [N]; | //In absolute time units measured from |
| | Jan. 1, //1970; see explanation of time |
| | variables below in //part II.C.3 |
| MATCH_TIME_INTERVAL [N]; | //In time units |
| MATCH_REPETITIONS [N]; | //In time units. Set to zero for unlimited |
| | //repetitions |
| ACTIVE_TIME_INTERVAL [N]; | //In time units. If “0”, offset not used |
| CYCLE_TIME_INTERVAL [N]; | //In time units. If “0”, offset not used |
| Parameters for Lot Objects: | |
| MinimumLotUnits [N]; | //Minimum number of units that can be |
| | //cleared by one order in this lot. |
| MaximumLotUnits [N]; | //Maximum number of units that can be |
| | //cleared by one order in this lot. |
| MinimumOfferUnits [N]; | //Minimum number of units that can be |
| | //cleared by one order in this offer. |
| MaximumOfferUnits [N]; | //Maximum number of units that can be |
| | //cleared by one order in this offer. |
| IncrementUnits [N]; | //If non-zero, any matching after |
| | //MininumOfferUnits must be divisible by |
| | this //number. Example: if |
| | MinimumOfferUnits is 5 //and |
| | IncrementUnits is 3, acceptable orders |
| | would //be 5, 8, 11, etc. |

Parameters Used in Client-side Implementations:

| | |
|---|---|
| Sealed_Bid [0\|1]; | //Bids are sealed if |
| | //Sealed_Bid is set to “1” |
| Sealed_Ask [0\|1]; | //Asks are sealed if |
| | //Sealed_Ask is set to “1” |
| Anonymous_Bid [0\|1]; | //Bids are anonymous if |
| | //Anonymous_Bid is set to “1” |
| Anonymous_Ask [0\|1]; | //Asks are anonymous if |
| | //Anonymous_Ask is set to “1” |

As noted, each exchange is conducted using a combination of instructions forming an instruction set. The instructions may be represented by inclusion of parameters, and parameters designating settings. The following represent a sampling of the possible auction types produced by trading system 100:

(1) English. One seller, many buyers. The auction has a time limit. Settlement occurs after the time limit expires. Seller has option to specify a minimum price (“reserve price”).

STRATEGY_TYPE=STRATEGY_EXCHANGE;
MATCH_TRIGGER=ON_ASK_COMMAND;
SETTLEMENT_POLICY=PAY_BID_PRICE;

| | |
|---|---|
| MAX_BIDS=[0-N]; | //“0” is unlimited bids |
| MAX_ASKS=1; | |
| DIRECTION=FORWARD; | |
| BID_QUIET_PERIOD=0; | |
| ASK_QUIET_PERIOD=0; | |

(2) Dutch. One seller, many buyers. Seller optionally specifies a reserve price. Auction has a time limit. Settlement occurs once after the time limit expires. After the time limit expires, no settlement occurs if an insufficient number of buyers bid at or above the reserve price to sell all items in auction. The settlement price for all successful buyers is the lowest winning bid. If the lowest successful bidder has asked for more items than are available (e.g. if the seller has 10 items and the four successful bids are 3,3,3,3), the lowest successful bidder receives a number of items less than his or her request (unless that bidder has requested all or none). The seller may also specify whether to accept bids if the successful bids do not purchase all of the seller's items.

STRATEGY_TYPE=STRATEGY_DUTCH;
MATCH_TRIGGER=ON_ASK_COMMAND;
SETTLEMENT_POLICY=[OP_PAY_LOWEST_WINNING |
OP_PAY_AVERAGE | OP_PAY_HIGHEST_WINNING];
MAX_BIDS=[0-N];
MAX_ASKS=1;
DIRECTION=FORWARD;
BID_QUIET_PERIOD=0;
ASK_QUIET_PERIOD=0;

(3) Vickrey. (Similar to Dutch). One seller, many buyers. Seller optionally specifies a reserve price. Auction has a time limit. Settlement occurs once after the time limit expires. After expiration, no settlement occurs if there are too few buyers over the reserve price. The settlement price for all successful buyers is the highest losing bid. Alternatively, the settlement price for all successful buyers is the lowest winning bid, or the next lowest price beneath each (a stair-step shift downward for each price). If the lowest successful bidder has asked for more items than are available, that bidder receives a number of items less than his or her request (unless that bidder has requested all or none). The seller may also specify whether to accept bids if the successful bids do not purchase all of the seller's items.

STRATEGY_TYPE=STRATEGY_DUTCH;
MATCH_TRIGGER=ON_ASK_COMMAND;
SETTLEMENT_POLICY=[PAY_HIGHEST_LOSING |
PAY_LOWEST_WINNING | PAY_STAIRSTEP];
MAX_BIDS=[0-N];
MAX_ASKS=1;
DIRECTION=FORWARD;
BID_QUIET_PERIOD=0;

(4) Yankee. (Similar to Dutch). One seller, many buyers. Seller optionally specifies a reserve price. Auction has a time limit. Settlement occurs once after the time limit expires. After expiration, no settlement occurs if there are too few buyers over the reserve price. All buyers pay their own bid price at settlement. If the lowest successful bidder has asked for more items than are available, that bidder receives a number of items less than his or her request (unless that bidder has requested all or none). The seller may also specify whether to accept bids if the successful bids do not purchase all of the seller's items.

STRATEGY_TYPE=STRATEGY_DUTCH;
MATCH_TRIGGER=ON_ASK_COMMAND;
SETTLEMENT_POLICY=OP_PAY_OWN;
MAX_BIDS=[0-N];
MAX_ASKS=1;
DIRECTION=FORWARD;
BID_QUIET_PERIOD=0;
ASK_QUIET_PERIOD=0;

(5) Japanese. One seller, many buyers. No time limit. Seller begins with a certain price, and gradually increments this price. At each increase in price, buyers must increase their bids to match, or drop out of the auction. Settlement occurs after all buyers but one have dropped out of the auction. To participate in the auction, buyers must agree to take all items offered by seller. Buyers cannot bid higher than the seller's current offer.

STRATEGY_TYPE=STRATEGY_JAPANESE;
MATCH_TRIGGER=ON_ASK;
SETTLEMENT_POLICY=OP_PAY_ASK_PRICE;
MAX_BIDS=[0-N];
MAX_ASKS=1;
DIRECTION=FORWARD;
BID_QUIET_PERIOD=0;

| | |
|---|---|
| ASK_QUIET_PERIOD=[0-N]; | //Time period for bidders to match ask |

(6) Classic English. (Similar to Japanese). One seller, many buyers. Seller starts “low”. After each new price by a buyer, buyers have a specified time period to increase their bids. Bids may exceed seller's price. Settlement occurs when no new bid is received within a time limit. Buyers cannot bid lower than the previous bid. Buyer must agree to buy all items.

STRATEGY_TYPE=STRATEGY_EXCHANGE;
MATCH_TRIGGER =[ON_BID | ON_OFFER];
SETTLEMENT_POLICY=OP_PAY_BID_PRICE;
MAX_BIDS=[0-N];
MAX_ASKS=1;
DIRECTION=FORWARD;

| | |
|---|---|
| BID_QUIET_PERIOD=[0-N]; | //For classic “barker” auction |
| ASK_QUIET_PERIOD=0; | |

(7) Classic Dutch. One seller, many buyers. No time limit. Seller starts “high” and continuously descends. Settlement occurs when a buyer agrees to accept the seller's offer. Buyer must agree to buy all items.

STRATEGY_TYPE=STRATEGY_EXCHANGE;
MATCH_TRIGGER=ON_ASK;
SETTLEMENT_POLICY=OP_PAY_ASK_PRICE;
MAX_BIDS=[0-N];
MAX_ASKS=1;
DIRECTION=FORWARD;
BID_QUIET_PERIOD=0;
ASK_QUIET_PERIOD=0;

(8) Exchange. Unlimited numbers of buyers and sellers. No time limit. Settlement occurs when a new offer (buy or sell) is added to the auction, or when an existing auction is updated. The settlement price can either be (a) the price offered by the seller; (b) the price offered by the buyer; (c) the price that was offered first between the two parties; (d) the price offered last between the two parties; and (e) the average price between the two.

STRATEGY_TYPE=STRATEGY_EXCHANGE;
MATCH_TRIGGER=[ON OFFER | ON_TIME_CONTROL
ON_EXTERNAL_EVENT];
SETTLEMENT_POLICY=[OP_PAY_ASK_PRICE | OP_PAY_BID_PRICE |
OP_PAY FIRST | OP_PAY_LAST | OP_PAY_AVERAGE];
MAX_BIDS=[0-N];
MAX_ASKS=[0-N];
DIRECTION=NEUTRAL;
BID_QUIET_PERIOD=[0-N];
ASK_QUIET_PERIOD=[0-N];

(9) Live Forward. (Similar to English auction). One seller, many buyers. Price varies continuously for both the seller and the buyers. No time limit.

STRATEGY_TYPE=STRATEGY_EXCHANGE;
MATCH_TRIGGER=[ON_ASK | ON_TIME_CONTROL |
ON_EXTERNAL_EVENT];
SETTLEMENT_POLICY=[OP_PAY_ASK_PRICE | OP_PAY_BID_PRICE |
OP_PAY_FIRST | OP_PAY_LAST | OP_PAY_AVERAGE];
MAX_BIDS=[0-N];
MAX_ASKS=1;
DIRECTION=FORWARD;
BID_QUIET_PERIOD=[0-N];
ASK_QUIET_PERIOD=[0-N];

(10) Live Reverse. (Similar to Reverse English auction). One buyer, many sellers. Price varies continuously for both the buyer and the sellers. No time limit.

STRATEGY_TYPE=STRATEGY_EXCHANGE;
MATCH_TRIGGER=[ON_BID | ON_TIME_CONTROL |
ON_EXTERNAL_EVENT];
SETTLEMENT_POLICY=[OP_PAY_ASK_PRICE | OP_PAY_BID_PRICE |
OP_PAY_FIRST | OP_PAY_LAST | OP_PAY_AVERAGE];
MAX_BIDS=1;
MAX_ASKS=[0-N];
DIRECTION=REVERSE;
BID_QUIET_PERIOD=[0-N];
ASK_QUIET_PERIOD=[0-N];

(11) Reverse English. One buyer, many sellers. The auction has a time limit. Settlement occurs after the time limit expires. Buyer optionally specifies a maximum price (“reserve price”).

STRATEGY_TYPE=STRATEGY_EXCHANGE;
MATCH_TRIGGER=ON_BID_CONTROL;
SETTLEMENT_POLICY=OP_PAY_BID_PRICE;
MAX_BIDS=1;
MAX_ASKS=[0-N];
DIRECTION=REVERSE;
BID_QUIET_PERIOD=0;
ASK_QUIET_PERIOD=0;

(12) Reverse Dutch. One buyer, many sellers. Buyer optionally specifies a reserve price. Auction has a time limit. Settlement occurs once after the time limit expires. After the time limit expires, no settlement occurs if an insufficient number of sellers bid at or below the reserve price. The settlement price for all successful sellers is the lowest winning bid. If the highest successful seller has agreed to sell more items than are available (e.g. if the buyer wants 10 items and the four successful sellers are 3,3,3,3), the lowest successful seller sells a number of items less than his or her request (unless that seller has requested all or none). The buyer may also specify whether to accept any asks at all if the successful asks do not cover all of the buyer's requests.

STRATEGY_TYPE=STRATEGY_DUTCH;
MATCH_TRIGGER=ON_BID_CONTROL;
SETTLEMENT_POLICY=[OP_PAY_HIGHEST_WINNING |
OP_PAY_AVERAGE | OP_PAY_LOWEST_WINNING];
MAX_BIDS=1;
MAX_ASKS=[0-N];
DIRECTION=REVERSE;
BID_QUIET_PERIOD=0;
ASK_QUIET_PERIOD=0;

(13) Reverse Vickrey. (Similar to Reverse Dutch). One buyer, many sellers. Buyer optionally specifies a reserve price. Auction has a time limit. Settlement occurs once after the time limit expires. After expiration, no settlement occurs if there are an insufficient number of sellers at or below the reserve price. The settlement price for all successful buyers is the highest losing seller's price. Alternatively, the settlement price for all successful sellers is the next highest price above each (a stair-step shift upward for each price). If the highest successful seller has attempted to sell more items than are available, that seller sells a number of items less than his or her request (unless that seller has requested all or none). The buyer may also specify whether to accept any asks at all if the successful asks do not cover all of the buyer's requests.

STRATEGY_TYPE=STRATEGY_DUTCH;
MATCH_TRIGGER=ON_BID_CONTROL;
SETTLEMENT_POLICY=[OP_PAY_HIGHEST_LOSING |
OP_PAY_HIGHEST_WINNING | OP_PAY_STAIRSTEP];
MAX_BIDS=1;
MAX_ASKS=[0-N];
DIRECTION=REVERSE;
BID_QUIET_PERIOD=0;
ASK_QUIET_PERIOD=0;

(14) Reverse Yankee. (Similar to Reverse Dutch). One buyer, many sellers. Buyer optionally specifies a reserve price. Auction has a time limit. Settlement occurs once after the time limit expires. After expiration, no settlement occurs if there are too few sellers at or below the reserve price. All sellers pay their own price at settlement. If the highest successful seller has asked for more items than are available, that seller receives a number of items less than his or her request (unless that seller has requested all or none). The buyer may also specify whether to accept any asks at all if the successful asks do not cover all of the buyer's requests.

STRATEGY_TYPE=STRATEGY_DUTCH;
MATCH_TRIGGER=ON_BID_CONTROL;
SETTLEMENT_POLICY=OP_PAY_OWN;
MAX_BIDS=1;
MAX_ASKS=[0-N];
DIRECTION=REVERSE;
BID_QUIET_PERIOD=0;
ASK_QUIET_PERIOD=0;

(15) Reverse Japanese. One buyer, many sellers. Buyer optionally specifies a reserve price. No time limit. Buyer begins with a certain price, and gradually decreases this price. At each decrease in price, sellers must decrease their bids to match, or drop out of the auction. Settlement occurs after all sellers but one have dropped out of the auction. To participate in the auction, sellers must agree to take all items offered by seller. Sellers cannot bid higher than the buyer's current offer.

STRATEGY_TYPE=STRATEGY_JAPANESE;
MATCH_TRIGGER=ON_BID;
SETTLEMENT_POLICY=OP_PAY_BID_PRICE;
MAX_BIDS=1;
MAX_ASKS=[0-N];
DIRECTION=REVERSE;

| | |
|---|---|
| BID_QUIET_PERIOD=[0-N]; | //Time period for askers to match bid |
| ASK_QUIET_PERIOD=0; | |

(16) Reverse Classic English. (Similar to Reverse Japanese). One buyer, many sellers. Buyer starts “high”. After each new price by a seller, sellers have a specified time period to decrease their bids. Settlement occurs when no new seller's offer is received within a time limit. Seller must agree to accept all of buyer's requests.

| STRATEGY_TYPE=STRATEGY_EXCHANGE; | |
|---|---|
| MATCH_TRIGGER=[ON_ASK \| ON_OFFER]; | |
| SETTLEMENT_POLICY=OP_PAY_ASK_PRICE; | |
| MAX_BIDS=1; | |
| MAX_ASKS=[0-N]; | |
| DIRECTION=REVERSE; | |
| BID_QUIET_PERIOD=0; | |
| ASK_QUIET_PERIOD=[0-N]; | //For reverse ″barker″ auction |

(17) Reverse Classic Dutch. One buyer, many sellers. No time limit. Buyer starts “low” and continuously increases his or her offer price. Settlement occurs when a seller agrees to accept the buyer's offer. Seller must agree to accept all of buyer's requests.

STRATEGY_TYPE=STRATEGY_EXCHANGE;
MATCH_TRIGGER=ON_BID;
SETTLEMENT_POLICY=OP_PAY_BID_PRICE;
MAX_BIDS=1;
MAX_ASKS=[0-N];
DIRECTION=REVERSE;
BID_QUIET_PERIOD=0;
ASK_QUIET_PERIOD=0;

(18) Live Dutch. Same as Dutch except auction does not have a time limit. At each settlement calculation, the auction engine applies the settlement rules for the Dutch auction-the settlement price for all successful buyers is equal to either (a) the lowest winning bid; (b) the average of all the bids; or (c) the highest winning bid. Seller may optionally impose a reserve price.

STRATEGY_TYPE=STRATEGY_DUTCH;
MATCH_TRIGGER=[ON_OFFER | ON_BID | ON_ASK |
ON_TIME_CONTROL | ON_EXTERNAL_EVENT];
SETTLEMENT_POLICY=[OP_PAY_LOWEST_WINNING |
OP_PAY_AVERAGE | OP_PAY_HIGHEST_WINNING];
MAX_BIDS=[0-N];
MAX_ASKS=1;
DIRECTION=FORWARD;
BID_QUIET_PERIOD=[0-N];
ASK_QUIET_PERIOD=[0-N];

(19) Live Reverse Dutch. Same as Reverse Dutch except auction does not have a time limit.

STRATEGY_TYPE=STRATEGY_DUTCH;
MATCH_TRIGGER=[ON_OFFER | ON_BID | ON_ASK |
ON_TIME_CONTROL | ON_EXTERNAL_EVENT];
SETTLEMENT_POLICY=[OP_PAY_HIGHEST_WINNING |
OP_PAY_AVERAGE | OP_PAY_LOWEST_WINNING];
MAX_BIDS=1;
MAX_ASKS=[0-N];
DIRECTION=REVERSE;
BID_QUIET_PERIOD=[0-N];
ASK_QUIET_PERIOD=[0-N];

(20) Exchange Dutch. Same as Exchange except the auction settlement rules are those of Live Dutch. Multiple buyers and sellers. Seller may optionally specify a reserve price.

STRATEGY_TYPE=STRATEGY_EXCHANGE;
MATCH_TRIGGER=[ON_OFFER | ON_TIME_CONTROL |
ON_EXTERNAL_EVENT];
SETTLEMENT_POLICY=[OP_PAY_LOWEST_WINNING |
OP_PAY_AVERAGE | OP_PAY_HIGHEST_WINNING];
MAX_BIDS=[0-N];
MAX_ASKS=[0-N];
DIRECTION=NEUTRAL;
BID_QUIET_PERIOD=[0-N];
ASK_QUIET_PERIOD=[0-N];

(21) Live Vickrey. Same as Vickrey except auction does not have a time limit. At each settlement calculation, the auction engine applies the rules for the Vickrey auction—the settlement price for all successful buyers is equal to either (a) the highest losing bid; (b) the lowest winning bid; or (c) the bid below each buyer (the stairstep function). Seller may optionally specify a reserve price.

STRATEGY_TYPE=STRATEGY_DUTCH;
MATCH_TRIGGER=[ON_OFFER | ON_BID | ON_ASK |
ON_TIME_CONTROL | ON_EXTERNAL_EVENT];
SETTLEMENT_POLICY=[PAY_HIGHEST_LOSING |
PAY_LOWEST_WINNING | PAY_STAIRSTEP];
MAX_BIDS=[0-N];
MAX_ASKS=1;
DIRECTION=FORWARD;
BID_QUIET_PERIOD=[0-N];
ASK_QUIET_PERIOD=[0-N];

(22) Live Reverse Vickrey. Same as Reverse Vickrey except auction does not have a time limit.

STRATEGY_TYPE=STRATEGY_DUTCH;
MATCH_TRIGGER=[ON_OFFER | ON_BID | ON_ASK |
ON_TIME_CONTROL | ON_EXTERNAL_EVENT];
SETTLEMENT_POLICY=[OP_PAY_HIGHEST_LOSING |
OP_PAY_HIGHEST_WINNING | OP_PAY_STAIRSTEP];
MAX_BIDS=1;
MAX_ASKS=[0-N];
DIRECTION=REVERSE;
BID_QUIET_PERIOD=[0-N];
ASK_QUIET_PERIOD=[0-N];

(23) Exchange Vickrey. Same as Exchange except auction settlement rules are those of Live Vickrey. Multiple buyers and sellers. Seller may optionally specify a reserve price.

STRATEGY_TYPE=STRATEGY_EXCHANGE;
MATCH_TRIGGER=[ON_OFFER | ON_TIME_CONTROL |
ON_EXTERNAL_EVENT];
SETTLEMENT_POLICY=[OP_PAY_HIGHEST_LOSING |
OP_PAY_HIGHEST_WINNING | OP_PAY_STAIRSTEP];
MAX_BIDS=[0-N];
MAX_ASKS=[0-N];
DIRECTION=NEUTRAL;
BID_QUIET_PERIOD=[0-N];
ASK_QUIET_PERIOD=[0-N];

(24) Negotiated Exchange/Soft Matching. Same as Exchange except auction engine calculates bids and asks but does not settle any transactions. Settlement is done off-line.

STRATEGY_TYPE=STRATEGY_EXCHANGE;
MATCH_TRIGGER=[ON_TIME_CONTROL | ON_EXTERNAL_EVENT];
SETTLEMENT_POLICY=[OP_PAY_ASK_PRICE | OP_PAY_BID_PRICE |
OP_PAY_FIRST | OP_PAY_LAST | OP_PAY_AVERAGE];
MAX_BIDS=[0-N];
MAX_ASKS=[0-N];
DIRECTION=[NEUTRAL | FORWARD | REVERSE];
BID_QUIET_PERIOD=[0-N];
ASK_QUIET_PERIOD=[0-N];

(25) Live Data Feed. Similar to Exchange. In the Live Data Feed auction, the Auction Engine engine schedules a synchronous (or optionally asynchronous) match upon receipt of external data. As external data is received, all market participants have an opportunity to recalculate their offers before a match occurs.

STRATEGY_TYPE=STRATEGY_EXCHANGE;
MATCH_TRIGGER=ON_EVENT;
SETTLEMENT_POLICY=[OP_PAY_ASK_PRICE | OP_PAY_BID_PRICE |
OP_PAY_FIRST | OP_PAY_LAST | OP_PAY_AVERAGE];
MAX_BIDS=[0-N];
MAX_ASKS=[0-N];
DIRECTION=[NEUTRAL | FORWARD | REVERSE];
BID_QUIET_PERIOD=0;
ASK_QUIET_PERIOD=0;

(26) English Relay. Two or more sellers, many buyers. Similar to English auction except that there can be multiple sellers. Each seller has a specific deadline. Matches occur at the expiration of each seller's deadline. The remaining buyers and sellers continue to the next deadline. This “relay” principle can be applied in many other auction types with fixed deadlines, such as the Dutch and Vickrey auctions, as well as their reverse variants.

| STRATEGY_TYPE=STRATEGY_EXCHANGE; | |
|---|---|
| MATCH_TRIGGER=ON_ASK_COMMAND; | |
| SETTLEMENT_POLICY=PAY_BID_PRICE; | |
| MAX_BIDS=[0-N]; | //″0″ is unlimited bids |
| MAX_ASKS=[0-N]; | //″0″ is unlimited asks |

DIRECTION=FORWARD;
BID_QUIET_PERIOD=0;
ASK_QUIET_PERIOD=0;

E. Exchange Engine for Universal Trading System

Embodiments of the invention include an engine for conducting a plurality of electronic exchanges over a network. The engine is coupleable to a plurality of traders operating terminals on a network. The engine includes a lot holder module and a match module. The lot handler modules a request to initiate an exchange for an item, and a selection of parameters from a plurality of parameters. In response to receiving the request, the lot holder module generates a lot object specifying the item and a set of rules associated with the lot object. The set of rules are specific to the selection of parameters. Subsequent in to generating the lot object, the lot holder receives a plurality of offers specifying the lot object. A match state is conducted using the set of rules to select at least one of the plurality of offers as a matched order for the item. The set of rules may correspond to an instruction set.

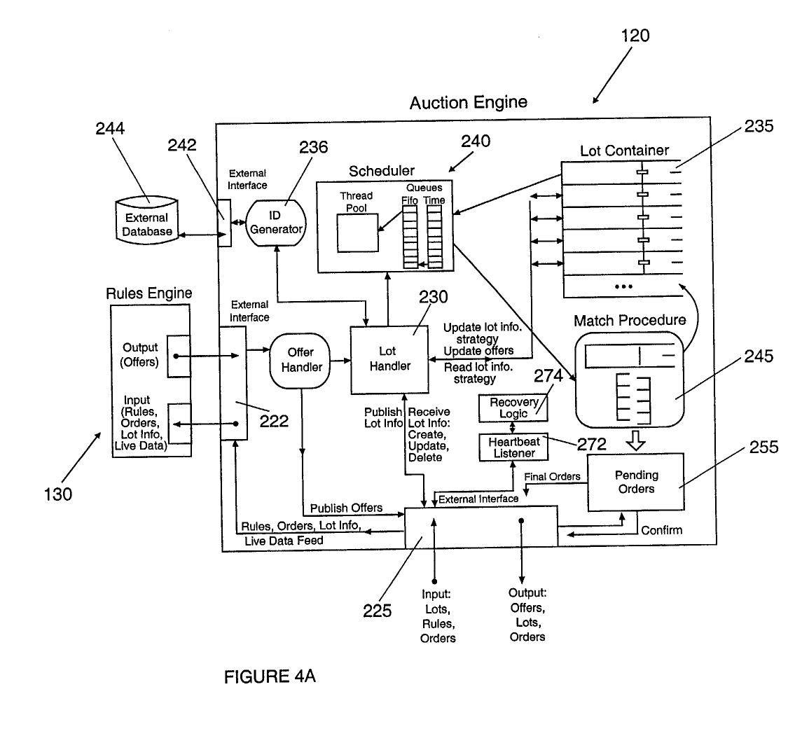

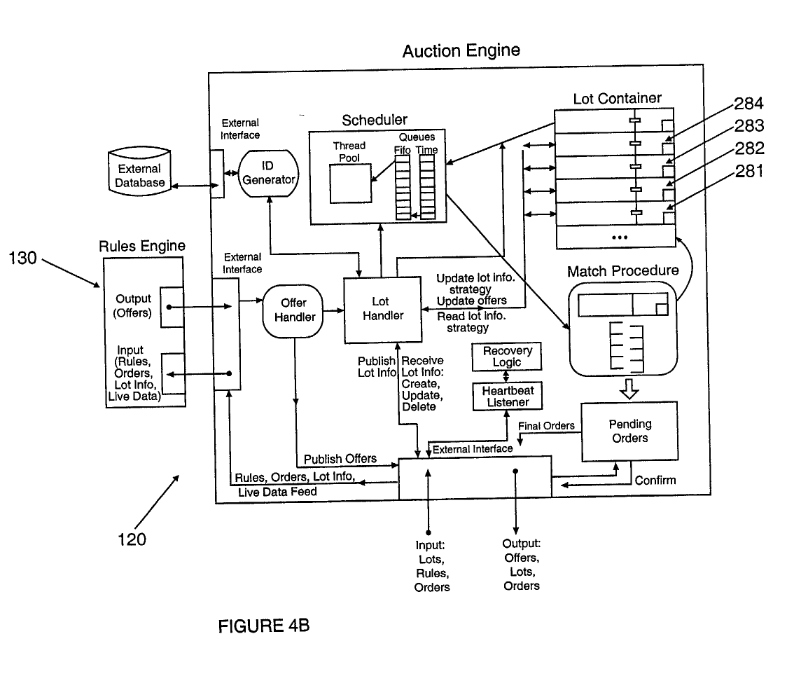

FIG. 4A is a block diagram of exchange engine 120, under an embodiment of the invention. The exchange engine 120 includes an external interface 225 that receives input from traders accessing the trading system 100 over the Internet. The exchange engine 120 includes a rule engine interface 222 for rule engine 130. The rule engine interface 222 is coupled to the external interface 225. An offer handler 232 is coupled to rule engine interface 222. A lot handler module 230 is coupled to offer handler 232. A lot container module 235 is signaled by the lot handler module 230. A scheduler 240 is coupled to lot handler module 230. A match state module 245 communicates with lot container module 235 and scheduler 240. An order module 255 processes pending orders signaled from match state module 245. The exchange engine 120 also includes a heartbeat listener 272 and a recovery logic 274.

Input received from traders across external interface 225 is forwarded to a rule engine interface 226. The input is signaled to rule engine 130 to identify a value or transactional price from the input. The rule engine 130 returns the input as the identified value to the rule engine interface 226. The rule engine interface 226 signals the value identified from the input to the offer handler module 232. The offer handler 232 signals the value of the input to lot handler module 230. The offer handler module 232 may also signal offers for publication to external interface 225.

Input received through external interface 225 may also include requests to create new lots and exchanges. The requests may include parameters to specify the type and manner of the exchange to determine the transactional value of the item specified in the exchange.

In an embodiment, input providing offers signaled to external interface 225 is in the form of a rule or compilation of instructions. The input rule may specify one or more offers. In particular, the input rule may be used to specify a plurality of offers for one exchange. The input rule may provide that select offers be signaled for the exchange upon a condition being specified. In its most basic form, a input rule may specify a single bid from a seller or bidder for submission to one of the exchanges being conducted on the trading system 100 (see FIG. 1). In a more complex example, during a Japanese Auction style exchange, the rule may specify a plurality of bid offers from a bidder, each bid offer increasing in increment with increase of the exchange price. In either case, external interface 225 signals the rule instruction to rule engine 130. The rule engine 130 decodes the input rule to identify one or more offers for a particular exchange. The offers may be submitted to the identified exchange when a specified condition of the input rule is met by that exchange. Alternatively, a score may be signaled to the specified auction, indicating a value of the offer, as well as other factors that may affect completion of the transaction based on that offer.

The rule engine interface 222 may communicate continuously with rule engine 130 to update the rule engine 130 on the state of exchanges being conducted under exchange engine 120. The rule engine 130 signals the offer or offer value (score, price etc.) to rule engine interface 222. This value is then signaled by rule engine interface 222 to offer handler module 232. The offer handler module 232 publishes the offer or value returned by rule engine 130. The offer handler module 232 also signals the offer value to lot handler module 230. Each offer is signaled with identification for the exchange, as well as for the trader making the offer. The lot handler module 230 may access ID generator 236 to reference the identifications received with the traders. The ID generator 236 may access a database 244 via database interface 242 for information matching the ID's signaled with each offer. The lot handler module 230 communicates with lot container 235 to place offers submitted from traders into identified exchanges.

In an embodiment, lot handler 230 also communicates with other components of exchange engine 120 to create exchanges and to enable exchanges to be performed. A requests to create new lots for exchanges may be received and handled by the lot handler module 230. The lot handler module 230 communicates with scheduler 240 to enable the new lot to be scheduled for a match state with match state module 245. The lot container module 235 stores lots with offers, as received from lot handler module 230.

The order module 255 receives orders from match state module 245. The pending orders are offers matched to one another (such as bid offers matched with ask offers). The order module 255 communicates with interface 225 to signal pending orders to messaging service 110 (FIG. 1). Signaling the pending orders enables for confirmation to take place. The confirmations may be received from external interface 225, and serve to finalize orders identified by the pending order module 260. The confirmation process may also identify pending orders that are canceled. Finalized orders are also signaled out through external interface 225.

FIG. 4B illustrates exchange engine 120 concurrently conducting multiple types of exchanges. The exchange engine 120 operates multiple lots 280-284, each represented by a lot object. Each lot object 280-284 may be different in its content, rules and instruction sets. Thus, multiple lot objects 280-284 may be operated by exchange engine 120, each lot object being associated with a corresponding strategy object having different instruction sets and methods. The lot objects 280-284 are stored with lot container module 245, until match state for each is triggered.

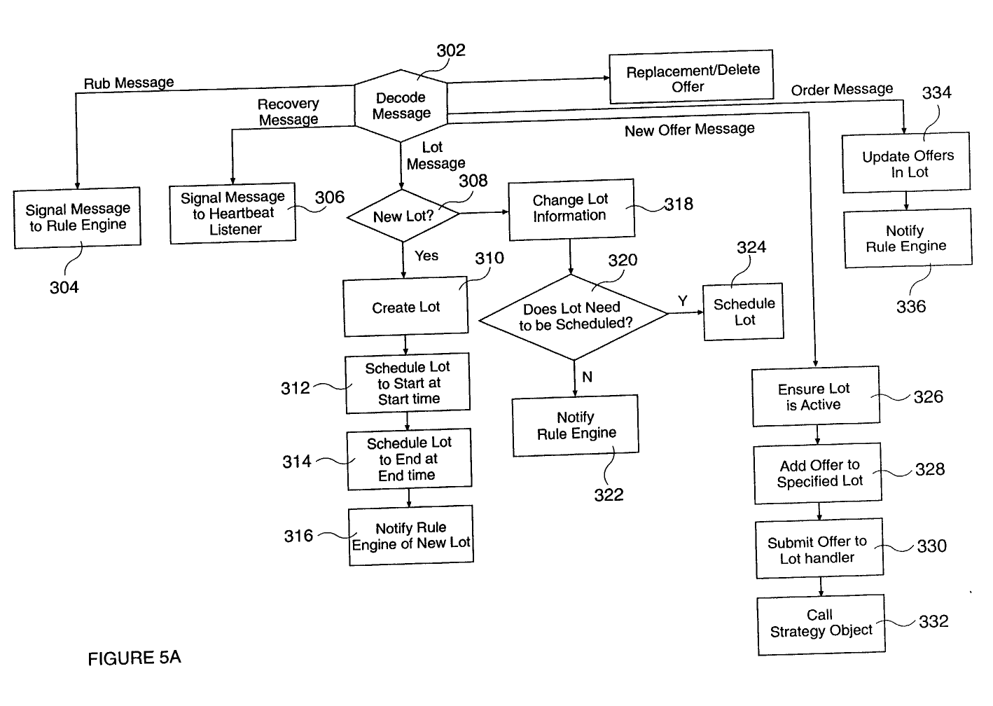

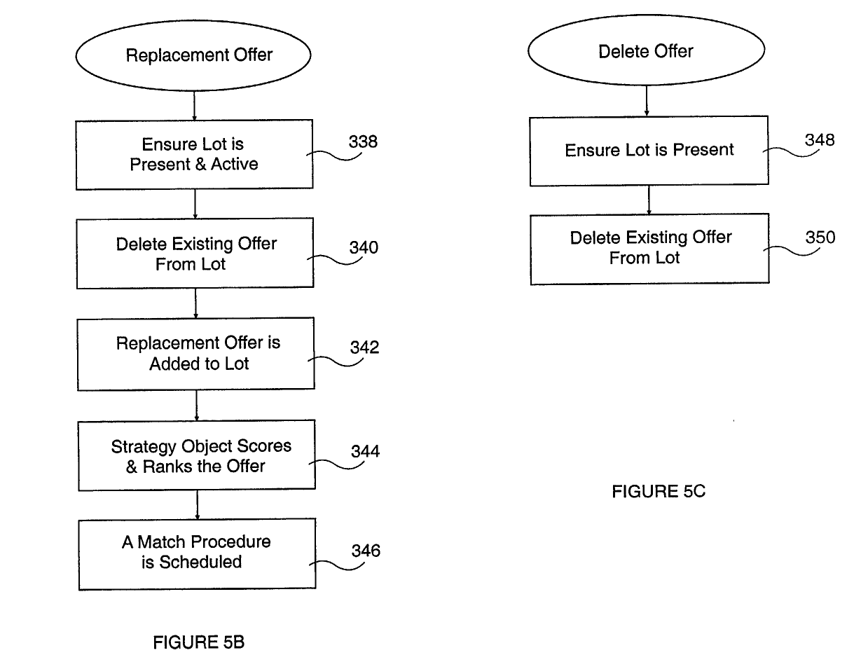

FIGS. 5A-5C illustrate processing of messages by exchange engine 120, under an embodiment of the invention. Initially, in step 302, a message is received and decoded by exchange engine 120. The message may be decoded as one of either a rule message, a recovery message, a lot message, a new offer message, an order message, a replacement offer message, or a delete order message. If the message is determined to be a rule engine message, then that message is forwarded to rule engine 130 for processing in step 304. A rule engine message corresponds to a input rule, comprising rules inputted by a trader for programmatically inputting offers. It should be noted that rule engine 130 can be replaced by any component or process that performs a similar function.

If the message decoded is determined to be a recover message, then in step 306, the message is signaled to heartbeat listener 272 and recovery logic 274.

If the message is determined in step 302 to be a lot message, then in step 308, a determination is made as to whether the lot message is a new lot message. If the lot message is a new lot message, step 310 provides that exchange engine 120 creates the new lot. This step may be performed by lot handler module 220. Step 312 provides that the new lot is to be scheduled for a start time. In step 314, the new lot is scheduled for a match state. Steps 312 and 314 may be performed by a combination of lot handler module 220 and scheduler 240. In step 316, rule engine 130 is notified of the new lot. If in step 308, the lot message is determined to include update information, then in step 318, the lot information is changed for that lot. Step 320 makes a determination as to whether the lot needs to be rescheduled. If the determination is to reschedule the updated lot, then step 324 provides that new updated lot be rescheduled. In step 322, rule engine 130 is notified of the updated lot.

If the message is determined in step 302 to be a new offer message, then in step 326, the lot is ensured to be active. The new offer may include identification for the trader, the lot and the offer. Step 326 may be performed by offer handler 232. The new offer is then added to the specified lot, using the identification specified with the new offer. Step 330 provides that the new offer is submitted to lot handler 230. In step 332, the strategy object for that lot is called. The strategy object may score and rank the new offer. A match procedure may be scheduled, if required.

If the message is determined in step 302 to be an order message, then step 334 provides that offers in the specified lot are updated. In step 336, rule engine 130 is notified of the order message.

FIG. 5B illustrates a process where the message decoded by exchange engine 102 is determined to be a replacement offer. The replacement offer includes an identification for the existing offer, an identification for the trader, and an identification for the lot. Step 338 provides that the lot is ensured to be present and active. This step may be performed by offer handler 232. In step 340, the existing offer is deleted from the lot specified with the replacement offer. Step 342 provides that the replacement offer is added to the lot. In step 344, the strategy object scores and ranks the replacement offer. These steps may be performed by lot handler module 230. Then in step 346, a match procedure is scheduled, preferably using lot handler module 230 and scheduler 340.

FIG. 5C illustrates a process where the message decoded by exchange engine 102 is determined to be a delete offer command. The delete offer message also includes an identification for the offer being deleted, the trader, and the exchange. In step 348, the lot specified by the delete offer is checked to ensure it is present and active. In step 350, the existing offer is deleted from the lot.

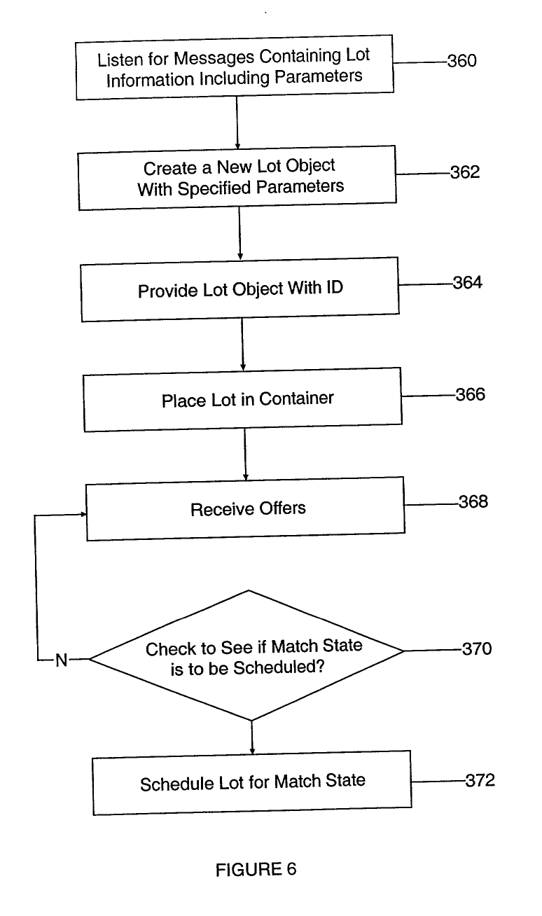

FIG. 6 illustrates a flow process for creating a new lot for an exchange, under an embodiment of the invention. In step 360, exchange engine 120 listens or waits for messages containing lot information. The lot information specifies an item for the lot. The lot information also specifies a combination of parameters for implementing instructions or rules for conducting the exchange. Under embodiments of the invention, the parameters may specify whether bidders and/or sellers may make offers, the settlement policy, and other characteristics for affecting the determination of the transactional value of the item being offered in the exchange. The request to create a new lot is routed from interface 225 to lot handler module 230.

In step 362, a lot object is created based on the request to create the new lot. The lot object may be associated with a strategy object. In an embodiment, the lot handler module 230 generates a new lot object based on the request. The lot handler module may associate or otherwise point the lot object to the strategy object.

In step 364, the lot object is provided an identification. The identification may be an ID provided by generator module 236. Concurrently, the lot object may be archived or stored in database 244, external to exchange engine 120.

In step 366, the lot object is stored to receive offers and await a signal for a match state. In an embodiment, lot handler module 230 places the lot object in lot container module 235 to await a match state signal.

In step 368, offers are received for the lot object. The offers may be signaled by traders through external interface 225, and forwarded to lot handler module 230. The offers include identifications for the trader making the offer, as well as the lot object. Based on the identification, the lot object is signaled to be stored in lot container module 235.

Sometime after offers are received, a determination is made in step 370 as to whether a match state needs to be created for the lot object. In an embodiment, lot handler module 230 accesses the instruction set of the lot object to make the determination as to whether a match state is to proceed for the lot object. If the determination of step 370 is negative, step 368 is repeated, and additional offers may be received.

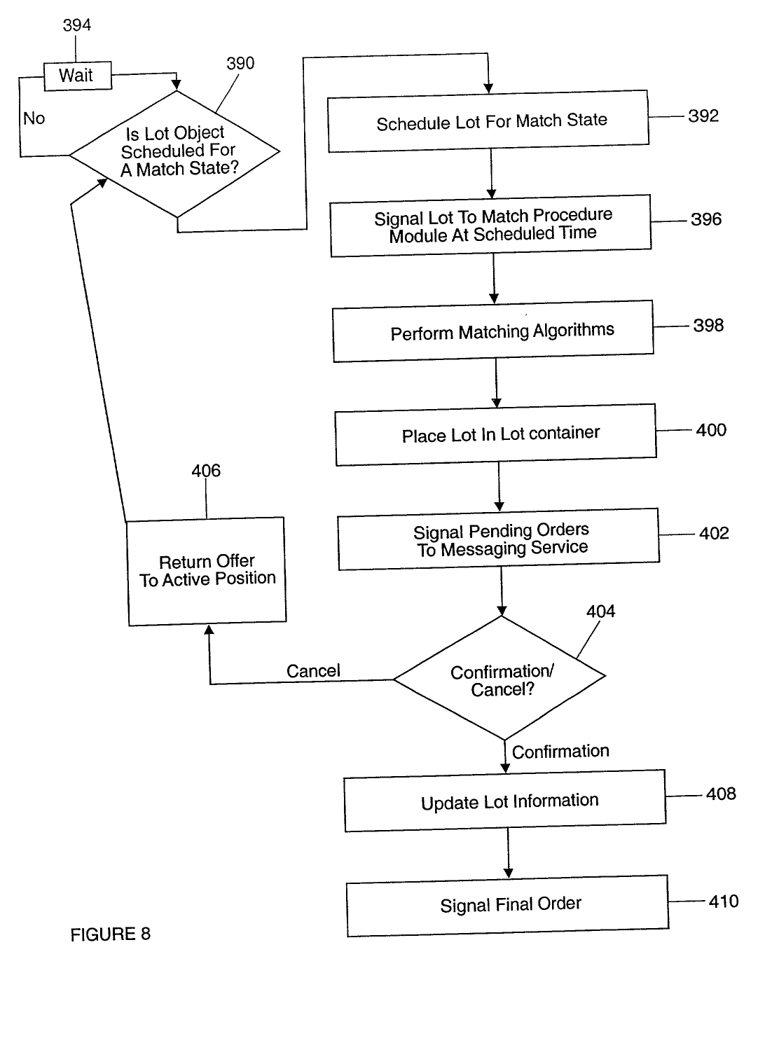

If the determination in step 370 is made to initiate the match state, the lot object is scheduled for the match state in step 372. The scheduler 235 may schedule the lot object for the match state. The lot object is forwarded from lot container module 235 to match state module 245. Further description of completing the match state is provided with FIG. 8.

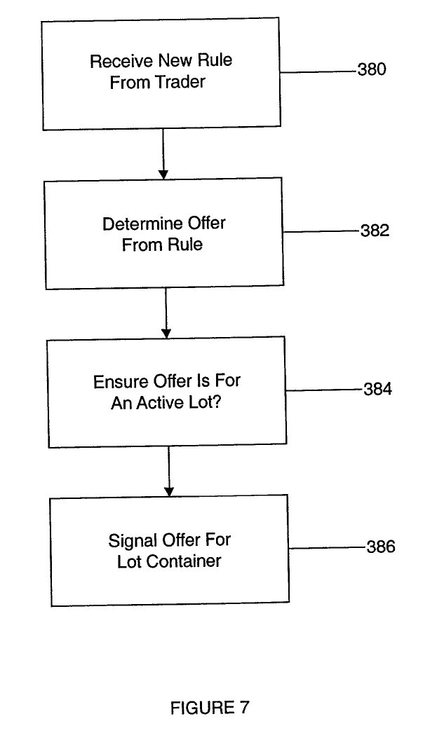

FIG. 7 illustrates a flow process illustrating exchange engine 120 handling new offers, under an embodiment of the invention. In step 380, a new input rule comprising one or more offers is received from one of the traders participating in the exchange specified with the lot. In step 382, a new offer is identified from the input rule. The rule engine 130 may be encoded to identify the offer from the input rule. In one embodiment, rule engine 130 may signal a plurality of new offers to lot handler module 230, based on instructions specified in the input rule.

In step 384, the new offer received is ensured to be for an active lot. An active is one in which match state has not yet occurred, or if it has occurred, failed to produce a confirmed order. The offer is then signaled for the lot object. In the embodiment provided by FIG. 2, the offer is signaled by lot handler 230 to lot container 240, which contains the lot object for that new offer.

FIG. 8 illustrates a process performed to match offers into pending orders. Offers are matched into pending orders when a match state is triggered. In an embodiment of the invention, the process described by FIG. 8 is performed by match state module 245, working in combination with lot handler module 230, scheduler 240 and lot container module 245.

In step 390, a determination is made as to whether the lot object is to be scheduled for a match state. The determination may be made by lot handler module 230, which accesses the instruction set 185, 195 (FIGS. 3A-3C) for each lot object 180 (FIGS. 3A-3C) and associated strategy object 190(FIGS. 3A-3C).

If the determination is to schedule the match state, in step 392, scheduler 340 schedules the lot object for a match state with match state module 245. In step 396, the match state is triggered, and the lot object 180 is signaled to match state module 245. Otherwise, in step 394, lot handler module 230 waits to recheck for the match state.

In step 398, matching algorithms are performed at match state module 245 to identify pending orders. The match state may use instruction sets 185, 195 in lot object 180 and strategy object 190 (FIGS. 3A-3C). The matching algorithms may correspond to the settlement policy. The match state involves matching one or more bid offers to one or more ask offers. The offers that are matched to one another become pending orders. The instruction sets 185, 195 determine a transactional value of the pending offers using parameters that configure the settlement policy. Thus, it is possible that the transactional value does not match a value of the pending order, or the values of the offers matched during the match state to form the pending orders.

Step 400 provides that the lot object is placed in lot container 245 after pending orders are identified. The lot container 245 may be in an inactive state, and not made active again unless pending orders are cancelled.

In step 402, the pending orders are delivered to messaging service 110 (FIG. 1). The pending orders may be signaled to messaging service 110 over external interface 225. In step 404, a determination is made as to whether the pending orders are cancelled or confirmed. If the pending order are cancelled, step 406 provides that the appropriate offers be returned to an active position in the offer list. The process maybe repeated, beginning with step 390.

If the pending orders are confirmed, the lot information is updated in step 408. In an embodiment, lot handler module 230 removes matched pairs of bid and ask offers from the lot object 180 (being stored in container module 245). The confirmation of the pending orders may be detected across external interface 225. If confirmation is received, the final order is sent out across the external interface 225 in step 410.

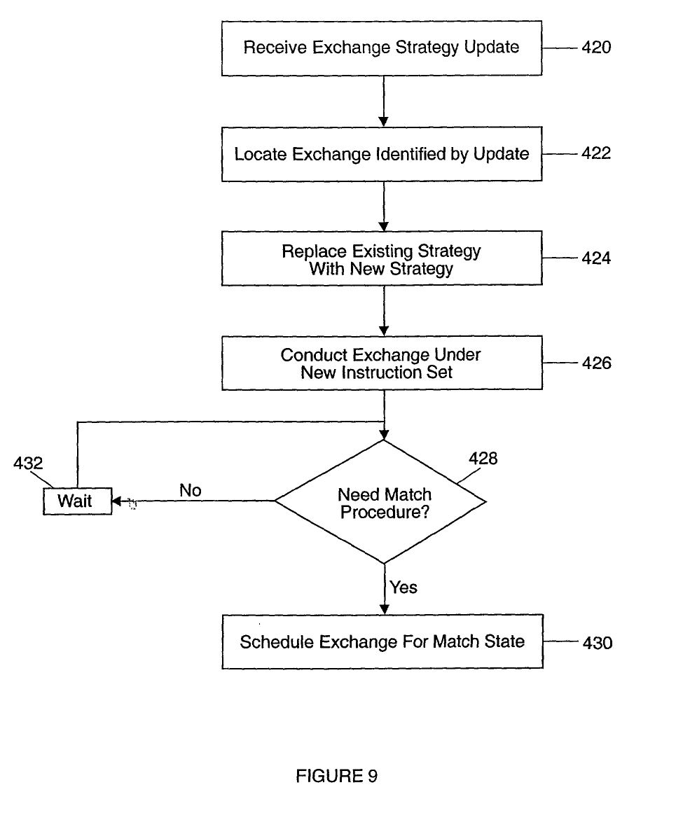

FIG. 9 illustrates a process in which the strategy for an exchange is changed while the exchange is in progress, or “on the fly.” The switch to a new strategy may occur after an offer has been received from one of the traders. As an example, an exchange under a variation of a Dutch Auction strategy may be switched over to an English type exchange, as described with FIG. 3B and 3C. In this example, strategy of the exchange may be switched after one or more bids have been received under the Dutch Auction style exchange. For illustrative purposes, reference is made to elements of FIG. 4A, showing components of exchange engine 120.

In step 420, an update on the exchange strategy is received by exchange engine 120. The update may be received after another input initially configures the exchange for a particular instruction set. The update may also be received after offers are forwarded to the exchange engine 120 for submission to the exchange, configured under the initial instruction set. In an embodiment shown by FIG. 4, the update may be received across external interface 225 and routed to lot handler module 230. The update may specify an identification of the lot object 180 (FIGS. 3A-3C) representing the exchange, having a particular strategy object 190 (FIGS. 3A-3C).

In step 422, the exchange specified by the update is located. With respect to exchange engine 120, the lot object 180 having the identification specified in the update is located by lot handler module 230. The lot handler module 230 may also locate the strategy object 190 associated with that lot object 180. An identification of the lot object 180 may be used to locate it within lot container module 235. The pointer 182 in lot object 180 identifies the strategy object 190.

In step 424, the existing strategy of the exchange is replaced with the new strategy. In an embodiment, the strategy object 190 is replaced with the an instruction set matching the update received in step 420. The new strategy object 190 may be signaled by lot handler module 230. Then, in step 426, the exchange for lot object 180 is conducted under a new instruction set. The new instruction set may affect the manner in which offers are received, the origination of each offers, the settlement procedure, the triggering event for match state, the direction of the exchange and other parameters.

In step 428, lot handler module 230 determines if the lot object 180 needs a match procedure. If the determination is positive, then in step 430, the lot object 180 is scheduled for the match state, to be performed by match state module 245. Otherwise, step 432 provides that the lot handler module 230 wait to check whether the match state needs to be scheduled.

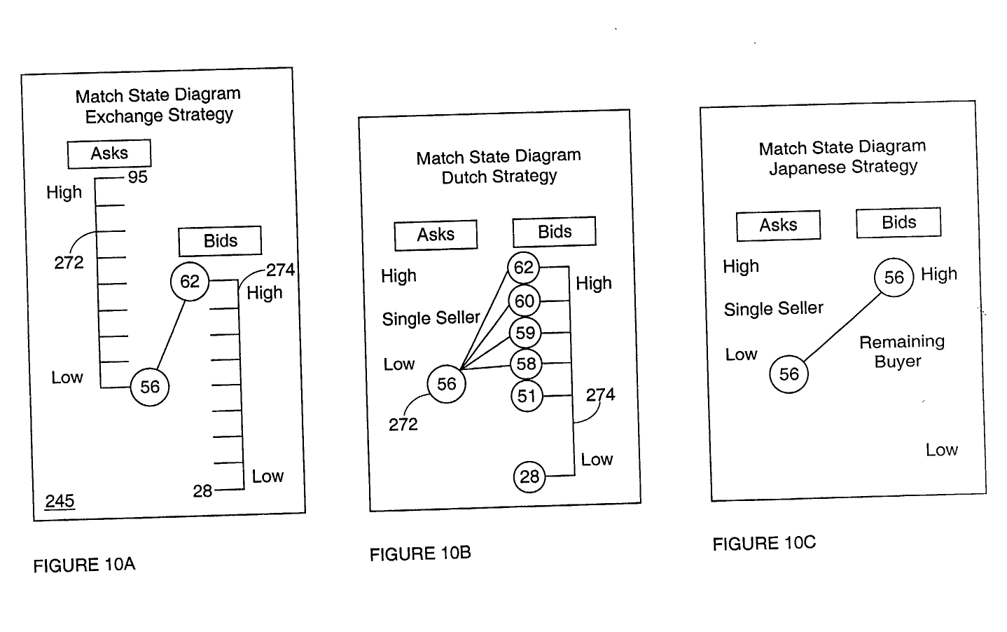

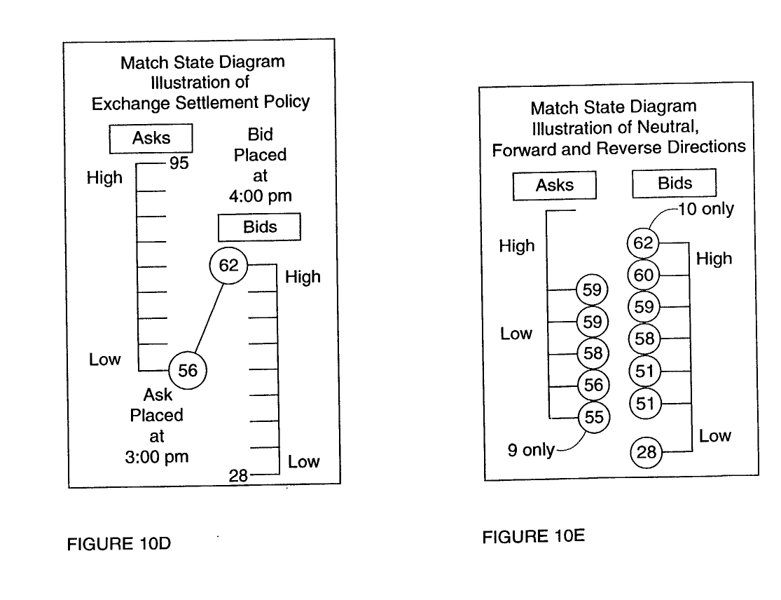

FIG. 10A-10E illustrate match state algorithms for determining matching offers under different exchange strategies. Each match state strategy may be performed by the match state module 245 of exchange engine 120. As shown, match state procedure module 245 retains a first data structure 272 for retaining ask offers, and a second data structure 274 for retaining bid offers. Preferably, the first and second data structures 272 and 274 are retained in a tree format. The match state algorithms affect determination of the transactional value of the item, depending on the particular strategies and settlement policies implemented.

In FIG. 10A, a General Exchange strategy is illustrated where the first data structure 272 stores a plurality of ask offers from a plurality of traders. The second data structure 274 stores a plurality of bid offers from a plurality of traders. During the match state for the General Exchange strategy, the match state module 245 attempts to match the lowest ask offer with the highest bid offer. The transactional value is based on the parameter for the settlement policy, along with the identified bid and ask offers. For example, the transactional value may be $56, corresponding to OP_PAY_ASK_PRICE being asserted with the configuration of the exchange. The transactional value may be $62, corresponding to OP_PAY_BID_PRICE being asserted in configuring the exchange. Still further, another example may provide the transactional value to be $59, based on OP_PAY_AVERAGE being asserted for the configuration of the exchange. One distinguishing feature of a strategy falling under the heading of General Exchange is that each buyer is matched up against one seller at a time.

FIG. 10B illustrates the match state performed by match state module 245 for a Dutch Auction type of exchange. In the first data structure 272, one ask offer exists or is otherwise pertinent. In the second data structure 274, a plurality of bid offers are stored. The matched state identifies all bid offers that are greater than or equal to the ask offer. The match state algorithms uses the bid offers to determine the transactional value for the lot. The specific settlement policy is configured using parameters. For example, the settlement policy my be asserted by OP_PAY_LOWEST_WINNING, which means the transactional value of an order completed by the identified bid offers is $58. Alternatively, the settlement policy my be asserted by OP_PAY_HIGHEST_LOSING, which means the transactional value of the pending orders (for the identified bid orders meeting or exceeding the ask offer) is $51.

In the Dutch Auction exchange, another parameter may designate that each winning bid offer is to pay the value of that offer, thereby resulting in multiple transactional values for items in a lot. This parameter is represented by OP_PAY_OWN, which would result in each bidder paying the value of their own bids as the transactional value ($62, $60, $59, and $58). Another parameter (represented by OP_PAY_HIGHEST_LOSING) may designate that in this type of exchange, each bidder matching or exceeding the ask offer pays for each item the value of the highest losing bid offer. If the second parameter is asserted, all of the bidders pay $51 for the item. Still further, another parameter (labeled by OP_PAY_LOWEST_WINNING) designates that the bidders submitting winning bid offers each pay the value of the lowest winning offer for the item. If the third parameter is asserted, all of the winning bidders pay $58 as the value of the item. Another parameter (OP_PAY_HIGHEST_WINNING) may be asserted so that all the winning bidders pay the value of the highest winning bid, which in the example provided is $62. Other examples of parameters that may be asserted in the Dutch Auction type of exchange include OP_PAY_LOWEST_LOSING (winning bidders pay the value of the lowest losing offer-$28) and OP_PAY_AVERAGE (winning bidders each pay the average value of all the winning bids-$59.75).

Another parameter that may be used to configure a Dutch Auction exchange may designate that a different transactional value be assigned for each bidder submitting a winning bid. In this configuration, the transactional value for each bidder is the next highest offer. This resulting Dutch Auction is a variation of the Vickrey Dutch Auction. The Vickrey auction was initially described by William Vickrey in 1961. [see Counterspeculation, Auctions, and Competitive Sealed Tenders, W. Vickrey, Journal of Finance, 16, 1961] The basic Vickrey auction consists of a single seller selling a single unit. The matching algorithm is that the highest bidder wins the good at the price offered by the second highest bidder, or highest losing price. The Vickrey auction is said to be desirable because it is incentive compatible—bidders have the incentive to bid their true valuation knowing they will pay less than they have actually bid.

In recent years, this concept has been extended to multi-unit bidding, most notably in the “Hambrecht IPO”-style auction (popularized by the brokerage firm W.R. Hambrecht) in which all winners pay the lowest winning price. Economists usually model the multi-unit version by assuming the price paid is the highest losing bid, because this has theoretical properties analogous to Vickrey's single-unit second-price case (see Auction Theory: A Guide to the Literature, Forthcoming in Journal of Economic Surveys, by Paul Klemperer, pg. 5, fn. 10).

In an embodiment, the exchange may be configured to execute a Vickrey Auction variation incorporating a stair-step concept. In this type of exchange, a set of winning bids are selected during the match state. The price (or transactional value) of each of the winning bids is actually the value of another one of the winning bids. Each winning bid may be priced at the next nearest winning bid. In a common implementation, each winning bid is priced at the lesser and closest price of another winning bid, so that each winning bid has a step-down in price. The lowest winning bid may be given a price of the highest losing offer. Other variations are possible. For example, each winning bid may be priced at the greater and closest price of another winning bid, with the highest winning bid given a predetermined price based on one of more of the winning bids.

For this type of exchange, the settlement policy may be designated by a parameter (labeled OP_PAY_STAIRSTEP) so that all winning bidders pay the price of the bid below themselves. This auction type preserves some of the incentive value of the original Vickrey (a winner pays a price below what he or she bid) but it also maximizes the revenue received by the seller: In many cases, the total amount paid will be greater than either OP_PAY_HIGHEST_LOSING or OP_PAY_LOWEST_WINNING, although there are cases in which the Vickrey Stairstep will result in the same payment or less than these other two systems (when all winning bidders have bid the same price, for example). In FIG. 8E, for example, the winning bidders would pay $60, $59, $58 and $51 under the OP_PAY_STAIRSTEP policy, for a total of $228. Under OP_PAY_HIGHEST_LOSING the total cash received would be $204, while in OP_PAY_LOWEST_WINNING the total received would be $232. In this example, therefore, the policy OP_PAY_LOWEST_WINNING would be slightly more beneficial to the seller. However, under certain conditions (such as a heavily sought-after auction) the Vickrey Stairstep would result in a higher payout for the seller than either of the other two types.

FIG. 10C illustrates the match state performed by match state module 245 for a Japanese Auction type of exchange. In the Japanese Auction strategy, a proposed price for the item is raised for buyers to match. The transactional value may be determined when bid offers stop exceeding the proposed transactional value. The first data structure 272 stores an ask offer. The ask offer may be designated prior to the exchange. The second data structure stores a plurality of bid offers, but uses the highest bid offer as the matched offer. In the example shown, the transactional value is $56.

One common feature of the Japanese Auction strategy is a wait period after when the proposed transactional value of the item is increased. For example, the seller may raise his or her price to allow the buyers to increase their bids. After a combination of one or more parameters designate the type of exchange as being the Japanese Auction strategy, another parameter may be identified by the trading engine as designating the wait period (e.g. variable BID_QUIET_PERIOD). Embodiments of the invention are allow for the wait period to be configurable, so that the may correspond to the time period after the last bid was made in order to enter a match state. In addition, the wait period is configurable to allow for offers from sellers to be subject to wait periods before the match sate is entered. Thus the variable ASK_QUIET_PERIOD is also available. If, for example, both wait period variables (BID_QUIET_PERIOD and ASK_QUIET_PERIOD) are both set to zero, there is no quiet period.

While the concept of wait periods has been discussed for use with Japanese Auction strategies, the two wait periods may be added to a variety of different auction types in order to elicit certain effects, such as an extension of the period within which offers can be made. The interoperability of the wait periods with other exchange strategies is an example of the unique configurations offered by embodiments of the invention.

Embodiments of the invention allow for the trading system to be configured to operate an exchange that implements the concept of wait periods. The exchange type is referred to herein as a Dual Wait Exchange. In the Dual Wait Exchange, both bid and ask quiet periods are set to different times. For example, in an exchange environment with three sellers and unlimited buyers, a market operator might wish to set the ASK_QUIET_PERIOD (the period of time after a seller changes his or her ask) to a longer time than the BID_QUIET_PERIOD (the period of time allotted for bidders to change the last bid offer). For example, if ASK_QUIET_PERIOD is set to one hour, and BID_QLIET_PERIOD is set to 10 minutes, a match state will not occur until either both one hour after the last ask offer is submitted (thereby changing the ask offer), and 10 minutes after the last bid offer is submitted (thereby changing the last bid offer). This new exchange type can be useful if, for example, a limited number of sellers rarely change their prices and therefore want a longer time (1 hour) to respond to each others' price changes, and if buyers are more active and a time period of 10 minutes is chosen for them (activity by the buyers might preclude a match if a longer period were used).

FIG. 10D illustrates the match state performed by match state module 245, configured for one or more particular settlement policy to determine the transactional value of the lot item. If the settlement policy is configured by asserting the parameter OP_PAY_ASK_PRICE, then the transactional value of the exchange is determined to be $56. If the settlement policy is set by asserting OP_PAY_BID_PRICE, then the transactional value is determined to be $62. For asserting OP_PAY_AVERAGE, it is $59.

In the example provided, the highest bid offer is signaled at 4:00 PM, and the lowest ask offer is signaled at 3:00 PM. The settlement policy may assert the parameter represented by OP_FIRST_IN_TIME, which in this case results in the transactional value being $56. That is, the OP_FIRST_IN_TIME parameter chose between the highest bid offer and the lowest ask offer, and the selection was made by which offer was received first. For asserting LAST_IN_TIME, the same methodology results in the transactional value being at $62, corresponding to the later bid offer. Of course, parameters represented OP_FIRST_IN_TIME and OP_LAST_IN_TIME could be used to determine the transactional value based on any settlement policy, such as one where the first-in-time offer is selected between the highest bid offer and the highest ask offer, or the two highest bid offers etc.

FIG. 10E is a diagram illustrating a FORWARD and REVERSE direction of an exchange, under an embodiment of the invention. The diagram illustrates functioning of match state module 245 to direct an exchange in a forward, reverse or neutral direction. If the exchange is run in the FORWARD direction, preference is given to satisfying the constraints of the sellers before the constraints of the buyers. Conversely, if the exchange is conducted in REVERSE, preference is given to satisfying the constraints of the buyers first.

In the example provided, the seller with the lowest ask of $55 requires that 9 items be purchased from one buyer during the exchange. On the bidder side, the high bidder at $62 requires that he purchase 10 items. Given this example, the selection of the direction parameter will affect the transactional value of the item. In the FORWARD direction, the seller's requirement of finding a buyer of all 9 items is carried out first. The bidder at $62 is skipped, since his requirement does not take precedence. In the REVERSE direction, the high bidder at $62 is satisfied with 9 items from the $55 bidder and one item from the $56 bidder.

The NEUTRAL direction has the following effects: First, the match state checks if either the lowest ask or the highest bid can be satisfied. In other words, if an attempt were made to match that bid or ask before any other, that bid or ask would be fulfilled, including all constraints that may be on that offer, such as a minimum or maximum number of items, etc. If only one can be satisfied, that bid or ask is fulfilled. If neither, the algorithm advances to the next pair highest in the asks and lower in the bids. If both can be satisfied, the algorithm accepts the bid or ask with the lowest minimum units requirements (e.g. a bid or ask for “at least 2” will be satisfied before a bid or ask with a requirement of “at least 3”). If both have equal minimum requirements, the bid or ask that was first in time is satisfied. If both were entered at the same time, the buyer's side is arbitrarily chosen to satisfy first. With reference to the example provided, the seller at $55 is matched with the bidder at $60, leaving the bidder at $62 not satisfied. Alternatively, the seller at $56 may be matched to the bidder at $60, leaving both the seller at $55 and the bidder at $62 unsatisfied.

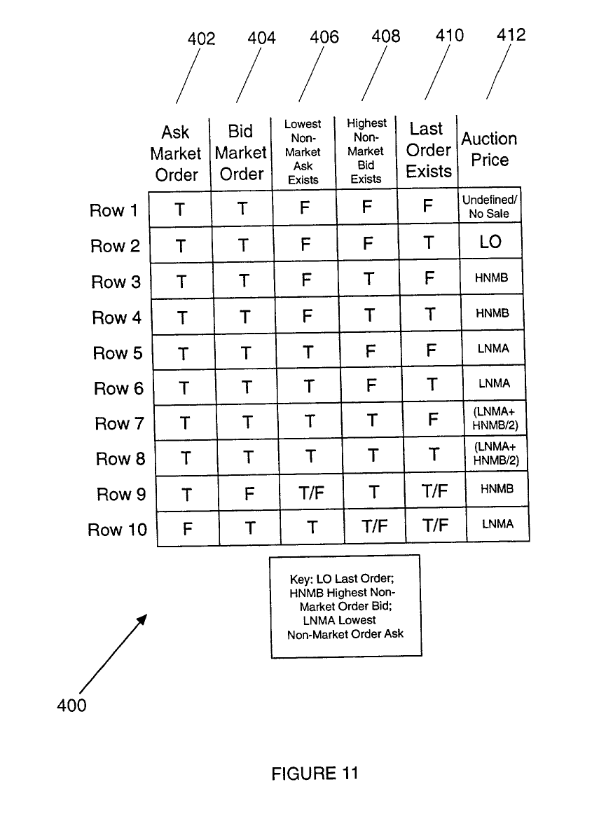

FIG. 11 is a chart 400 illustrating operational guidelines for exchange engine 120 to execute “market orders”, where the market price of an item is ambiguous. The methodology described with FIG. 11 is intended to be exemplary. For example, some exchanges may allow simultaneous offers from both sellers and bidders. In such instances, the agreed price is uncertain. During the match state, the lot object produces a price for the exchange according to the conditions outlined in the chart of FIG. 11.

With reference to chart 400, column 402 indicates existence of an ask offer from a seller. Column 404 indicates existence of a bid offer. The column 406 indicates whether a lowest, non-market ask offer exists(LNMA). The column 408 indicates whether a highest, non-market bid exists (HNMB). The column 410 indicates whether a last order has been made. The column 412 provides the transactional value-i.e. the price for the lot when the match state occurs. The code listed in column 412 corresponds to one of the columns 402-410.

In this way, chart 400 prioritizes conditions for determining the transactional value of an item in such an exchange. For example, as shown by rows 5 and 6, if there is both an ask offer (column 402), bid offer (404), and there is a LNMA (column 406) but no HNMB (column 408), the priority scheme set forth chooses the LNMA as the transactional value of the item. In another example shown by rows 3 and 4, if the HNMB exists, but the LNMA does not, the transactional value is designated as the HNMB, regardless of whether the last order exists.

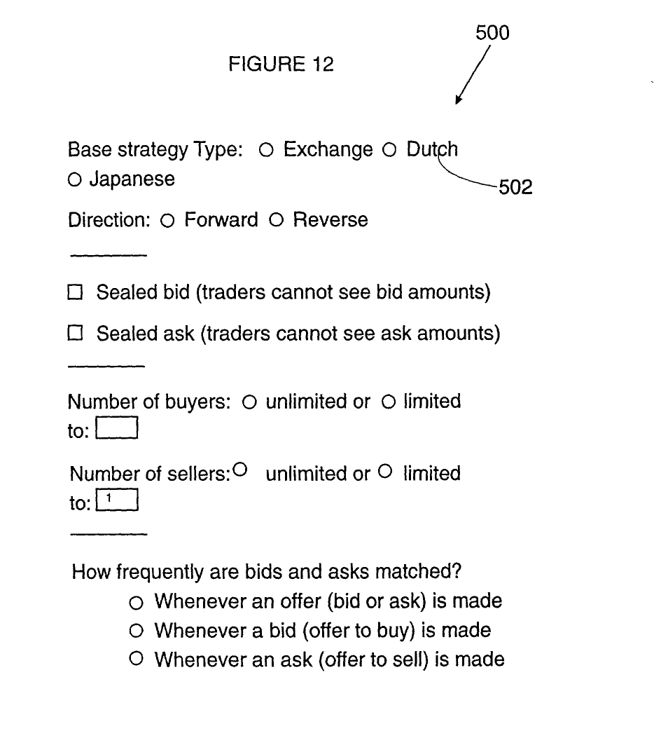

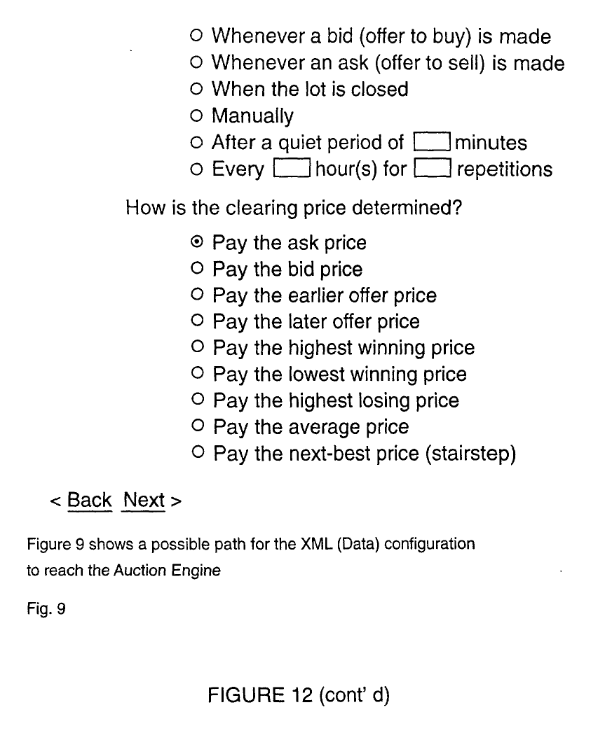

FIG. 12 illustrates a user-interface 500 for use with trading system 100, under an embodiment of the invention. The user-interface 500 enables selection of parameters that form the instruction set for each exchange. In an embodiment, a seller requests to initiate an exchange to sell a particular goods or services. The seller may also specify the parameters that determine the instruction set for each exchange. In particular, user-interface 500 enables selection of parameters for determining instructions sets 185, 195 of the lot objects identifying each exchange.

The user-interface 500 includes a plurality of user-interactive features, each of which prompt a trader to make a selection. The user-interface features may be in the form of check-fields, to enable users to select whether to assert particular parameters. Examples of user-interactive features include icons, menu items, selectable links, checkfields and text entry fields.

In the example shown, each major selection such as corresponding to exchange type, settlement criteria, exchange direction and match state procedures, a plurality of checkfields 502 are provided. Each checkfield corresponds to a setting for the major selection. The user-interface 500 may also include other text fields for entering configuration information, such as the size of the bidders or traders in the group. The combination of settings selected through user-interface 500 form the combinations of instructions for the instruction sets 185, 195.

F. Conclusion

The foregoing description of various embodiments of the invention has been presented for purposes of illustration and description. It is not intended to limit the invention to the precise forms disclosed. Many modifications and equivalent arrangements will be apparent.

What is claimed is:

1. A method for conducting a plurality of electronic exchanges over a network, each exchange being conducted between a plurality of traders, the plurality of traders comprising a set of sellers and a set of bidders, each of the plurality of traders being on a terminal coupled to the network, each exchange being conducted to determine a transactional value of an item, the method comprising:
receiving a plurality of requests, each request being made by one of the plurality of traders to initiate one of the plurality of exchanges;
identifying a plurality of parameters selected by at least one of the plurality of traders for each of the plurality of exchanges;
receiving a plurality of offers for each of the plurality of exchanges;
for at least one of the plurality of exchanges:
designating a settlement criteria from the plurality of parameters in which one of the plurality of offers is to be selected for determining the transactional value of the item;
detecting an external event over the network; and
upon occurrence of the external event, determining the transactional value of the item for that exchange using the selected offer.

2. The method of claim 1, wherein for at least one of the exchanges, detecting the external event includes receiving information for determining the transactional value of the item.

3. The method of claim 2, receiving information for determining the transactional value of the item includes receiving pricing information for determining the transactional value of the item.

4. The method of claim 2, receiving information for determining the transactional value of the item includes receiving pricing information for determining the transactional value of the item from another market.

5. The method of claim 2, wherein for at least one of the exchanges, the method further comprises determining the transactional value of the item upon receiving a signal carrying real-time updates on a dynamic characteristic of the item.

6. The method of claim 1, further comprising for at least some of the plurality of exchanges, designating an origination for each of the plurality of offers as being from either the set of sellers or the set of bidders.

7. The method of claim 1, further comprising designating the settlement criteria for identifying a first offer from one of the set of sellers or the set of bidders as matching a second offer from the other of the set of sellers or the set of bidders.

8. A method for determining a transactional value of an item offered for exchange by a seller for a bidder, the first seller being on a first terminal coupled to a network to make an ask offer, the bidder trader being on a second terminal coupled to the network to make a bid offer, the method comprising:
receiving a first signal to initiate an exchange;
identifying a first parameter from the first signal that corresponds to a first period of time for the seller to alter an existing ask offer;
identifying a second parameter from the first signal that corresponds to a second period of time for the bidder to alter an existing bid offer; and
determining the transactional value of the item using the existing ask offer after the first period has elapsed and using the existing bid offer after the second period has lapsed.

9. The method of claim 8, wherein the first period is longer than the second period.

10. The method of claim 8, wherein the first period is shorter than the second period.

11. The method of claim 8, wherein identifying a first parameter from the first signal includes identifying a plurality of parameters, including the first parameter and the second parameter.

12. The method of claim 8, wherein identifying a plurality of parameters includes identifying a third parameter designating a settlement policy for determining the transactional value of the item based on the existing ask offer and the existing bid offer after the first period and the second period have elapsed.

13. A method for conducting an electronic exchange over a network, the exchange being conducted between a plurality of traders, the plurality of traders comprising a set of sellers and a set of bidders, each of the plurality of traders being on a terminal coupled to the network, the exchange being conducted to determine a transactional value for each item in a plurality of items, the method comprising:
receiving a plurality of offers for the exchange;
identifying a plurality of acceptable offers from the plurality of offers, each acceptable offer specifying a value, each acceptable offer being for exchanging one of the plurality of items; and
determining the transactional value of the item being exchanged with each of the acceptable offers as being a value of another acceptable offer in the plurality of acceptable offers.

14. The method of claim 13, wherein for each acceptable offer, determining the value of the item being exchanged includes identifying a nearest value of another acceptable offer as the transactional value.

15. The method of claim 13, wherein for each acceptable offer, determining the value of the item being exchanged includes identifying a lesser and nearest value of another acceptable offer as the transactional value.

16. A method for determining a transactional value of an item offered for exchange by a seller for a bidder, the seller being on a first terminal coupled to a network to make an ask offer, the bidder being on a second terminal coupled to the network to make a bid offer, the method comprising:
receiving a plurality of offers, including an existing ask offer from the seller and an existing bid offer from the bidder;
selecting a first period of time for the seller to alter the existing ask offer;
selecting a second period of time for the bidder to alter the existing bid offer; and
determining the transactional value of the item using the existing ask offer after the first period has elapsed and using the existing bid offer after the second period has lapsed.

17. A method for determining a transactional value of a plurality of items offered for exchange by at least a first seller for a plurality of bidders, the first seller being on a first terminal coupled to a network to make an ask offer, the plurality of bidder being on a second terminal coupled to the network to make a plurality of bid offers, the method comprising:
receiving a plurality of offers from the traders, including the plurality of bid offers;
periodically selecting a set of bid offers from the plurality of bid offers, each of the selected bid offers being for one of the plurality of items of the exchange; and
periodically determining the transactional value for the set of bid offers using one of the bid offers in the set of bid offers.

18. The method of claim 17, further comprising:
removing the selected set of bid offers from the plurality of bid offers after determining the transactional value for the set of bid offers.

19. The method of claim 18, further comprising periodically selecting a set of bid offers from the plurality of bid offers so that a size of the plurality of bid offers becomes less each time after selecting the set of bid offers.

20. The method of claim 17, periodically selecting a set of bid offers from the plurality of bid offers includes selecting bid offers using a predetermined criteria.

21. The method of claim 20, periodically selecting a set of bid offers from the plurality of bid offers includes selecting bid offers using the ask offer from the seller.

22. A method for conducting a plurality of electronic exchanges over a network, each exchange being conducted between a set of sellers and a set of bidders, the set of sellers including at least a first seller on a first terminal coupled to the network, the set of bidders including at least a first bidder on a second terminal coupled to the network, each exchange being conducted to determine a transactional value of an item, the method comprising:
receiving a plurality of requests, each request being made to initiate one of the plurality of exchanges in which a plurality of offers are used to determine the transactional value;
identifying a plurality of parameters selected by the first seller or the first bidder for each of the plurality of exchanges being initiated by one of the plurality of requests;
conducting each of the plurality of exchanges according to an instruction set determined by the plurality of parameters, wherein for a first exchange in the plurality of exchanges for exchanging a plurality of items, conducting the first exchange includes:
receiving a plurality of bid offers from the set of bidders;
periodically selecting a set of bid offers from the plurality of bid offers, each of the selected bid offers being for one of the plurality of items of the exchange; and
periodically determining the transactional value for the set of bid offers using one of the bid offers in the set of bid offers.
